(19) United States
(12) Patent Application Publication
(10) Pub. No.: US 2024/0276195 A1
(43) Pub. Date: Aug. 15, 2024

(54) SYSTEMS AND METHODS FOR USER EQUIPMENT AWARENESS FOR L4S IN CELLULAR NETWORKS BASED ON REGISTRATION AREA LEVEL

(71) Applicant: Meta Platforms Technologies, LLC, Menlo Park, CA (US)

(72) Inventors: Curt Wong, Bellevue, WA (US); Xiaodi Zhang, San Ramon, CA (US); Jiansong Wang, Lincroft, NJ (US)

(73) Assignee: Meta Platforms Technologies, LLC, Menlo Park, CA (US)

(21) Appl. No.: 18/397,464

(22) Filed: Dec. 27, 2023

Related U.S. Application Data
(60) Provisional application No. 63/444,398, filed on Feb. 9, 2023.

(51) Int. Cl. H04W 8/08; H04W 28/02

(52) U.S. Cl. CPC H04W 8/08; H04W 28/0289

(57) ABSTRACT

Systems, methods, and apparatuses for transmitting, by a wireless communication device, to an access management function (AMF) of a core network, a request for a session to be established with a wireless communication node, the request indicating a low queuing latency, low loss, and scalable throughput (L4S) protocol is to be used for the session, and a registration area corresponding to the wireless communication node, and receiving, by the wireless communication device, via the AMF from a session management function (SMF) of the core network, a response to the request, the response indicating that the L4S protocol is supported by the wireless communication node according to the registration area.

### CROSS REFERENCES TO RELATED PATENT APPLICATIONS

This application claims priority to U.S. Provisional Patent Application No. 63/444,398 filed Feb. 9, 2023 which is incorporate herein by reference in its entirety.

### FIELD OF DISCLOSURE

The present disclosure is generally related to wireless communication between devices, including but not limited to, systems and methods of user equipment awareness for low queuing latency, low loss, and scalable throughput (L4S) protocol(s) in cellular networks based on registration area level.

### BACKGROUND

Augmented reality (AR), virtual reality (VR), and mixed reality (MR) are becoming more prevalent, which such technology being supported across a wider variety of platforms and device. Some AR/VR/MR devices may communicate via cellular connections with various cellular equipment/cell sites/base stations. Some cellular equipment may support L4S protocol(s).

### SUMMARY

In one aspect, this disclosure relates to a method. The method includes transmitting, by a wireless communication device, to an access management function (AMF) of a core network, a request for a session to be established with a wireless communication node, the request indicating a low queuing latency, low loss, and scalable throughput (L4S) protocol is to be used for the session, and a registration area corresponding to the wireless communication node. The method further includes receiving, by the wireless communication device, via the AMF from a session management function (SMF) of the core network, a response to the request, the response indicating that the L4S protocol is supported by the wireless communication node according to the registration area.

In some embodiments, the SMF determines that the L4S protocol is supported by the wireless communication node, based on determining that each wireless communication node in the registration area support the L4S protocol.

In some embodiments, the SMF determines that each wireless communication node in the registration area support the L4S protocol by querying a network repository function (NPF) of the core network.

In some embodiments, the request is sent at a first time instance and the wireless communication node is a first wireless communication node. In some embodiments, the method further includes initiating, by the wireless communication device responsive to a mobility event at a second time instance to a second registration area, a mobility registration update procedure with the AMF. In some embodiments, the method further includes receiving, by the wireless communication device, via the AMF from the SMF, an indication indicating the L4S protocol is not supported in the second registration area.

In some embodiments, the method further includes performing congestion control using a congestion control protocol other than the L4S protocol.

In some embodiments, the method further includes performing, by the wireless communication device, with a server, an L4S validation using an application procedure, to determine whether the L4S protocol is supported along an end-to-end network path between the wireless communication device and the server.

In some embodiments, the method further includes transmitting, by the wireless communication device, to the AMF, during a periodic registration procedure, a message to confirm that the L4S protocol is to be maintained for the session. In some embodiments, the method further includes receiving, by the wireless communication device, a second response to the message, the second response indicating that the L4S protocol is supported by the wireless communication node based on the registration area.

In some embodiments, the response is received in a session accept message from the SMF.

In one aspect, this disclosure relates to a wireless communication device. The wireless communication device includes a transceiver and one or more processors. The one or more processors transmit, by a wireless communication device, to an access management function (AMF) of a core network, a request for a session to be established with a wireless communication node, the request indicating a low queuing latency, low loss, and scalable throughput (L4S) protocol is to be used for the session, and a registration area corresponding to the wireless communication node. The one or more processors further receive, by the wireless communication device, via the AMF from a session management function (SMF) of the core network, a response to the request, the response indicating that the L4S protocol is supported by the wireless communication node based on the registration area.

In some embodiments, the SMF determines that the L4S protocol is supported by the wireless communication node, based on determining that each wireless communication node in the registration area support the L4S protocol.

In some embodiments, the SMF determines that each wireless communication node in the registration area support the L4S protocol by querying a network repository function (NPF) of the core network.

In some embodiments, the request is sent at a first time instance and the wireless communication node is a first wireless communication node. In some embodiments, the one or more processors are further configured to initiate, by the wireless communication device responsive to a mobility event at a second time instance to a second registration area, a mobility registration update procedure with the AMF. In some embodiments, the one or more processors are further configured to receive, by the wireless communication device, via the AMF from the SMF, an indication indicating the L4S protocol is not supported in the second registration area.

In some embodiments, the one or more processors are further configured to perform congestion control using a congestion control protocol other than the L4S protocol.

In some embodiments, the one or more processors are further configured to perform, by the wireless communication device, with a server, an L4S validation using an application procedure, to determine whether the L4S protocol is supported along an end-to-end network path between the wireless communication device and the server.

In some embodiments, the one or more processors are further configured to transmit, by the wireless communication device, to the AMF, during a periodic registration procedure, a message to confirm that the L4S protocol is to be maintained for the session. In some embodiments, the one or more processors are further configured to receive, by the wireless communication device, a second response to the message, the second response indicating that the L4S protocol is supported by the wireless communication node based on the registration area.

In some embodiments, the response is received in a session accept message from the SMF.

In one aspect, this disclosure relates to a non-transitory computer readable medium storing instructions that, when executed by one or more processors, cause the one or more processors to transmit, by a wireless communication device, to an access management function (AMF) of a core network, a request for a session to be established with a wireless communication node, the request indicating a low queuing latency, low loss, and scalable throughput (L4S) protocol is to be used for the session, and a registration area corresponding to the wireless communication node. The instructions further cause the one or more processors to receive, by the wireless communication device, via the AMF from a session management function (SMF) of the core network, a response to the request, the response indicating that the L4S protocol is supported by the wireless communication node based on the registration area.

In some embodiments, the SMF determines that the L4S protocol is supported by the wireless communication node, based on determining that each wireless communication node in the registration area support the L4S protocol.

In some embodiments, the SMF determines that each wireless communication node in the registration area support the L4S protocol by querying a network repository function (NPF) of the core network.

In some embodiments, the request is sent at a first time instance and the wireless communication node is a first wireless communication node. In some embodiments, the instructions further cause the one or more processors to initiate, by the wireless communication device responsive to a mobility event at a second time instance to a second registration area, a mobility registration update procedure with the AMF. In some embodiments, the instructions further cause the one or more processors to receive, by the wireless communication device, via the AMF from the SMF, an indication indicating the L4S protocol is not supported in the second registration area.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of an example wireless communication system, according to an example implementation of the present disclosure.

FIG. 2 is a diagram of a console and a head wearable display for presenting augmented reality or virtual reality, according to an example implementation of the present disclosure.

FIG. 3 is a diagram of a head wearable display, according to an example implementation of the present disclosure.

FIG. 4 is a block diagram of a computing environment according to an example implementation of the present disclosure.

FIG. 5 is a block diagram of an example wireless communication system, according to an exemplary embodiment.

FIG. 6 is a process flow of an example wireless communication system with an initial L4S establishment, according to an exemplary embodiment.

FIG. 7 is a flow diagram of method of implicit detection of L4S awareness, according to an exemplary embodiment.

FIG. 8 is a process flow of a reestablishment of a data session with L4S awareness in example wireless communication system, according to an exemplary embodiment.

FIG. 9 is a process flow of a connected mode mobility of an example wireless communication system with L4S awareness, according to an exemplary embodiment.

FIG. 10 is a process flow of a connected mode mobility of an example wireless communication system with L4S awareness, according to an exemplary embodiment.

FIG. 11 is a flow diagram of a method of L4S detection with a per node level capability exchange, according to an exemplary embodiment.

FIG. 12 is a process flow of an example wireless communication system with an initial L4S establishment, according to an exemplary embodiment.

FIG. 13 is a flow diagram of a method for indicating L4S support at a registration area level, according to an exemplary embodiment.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

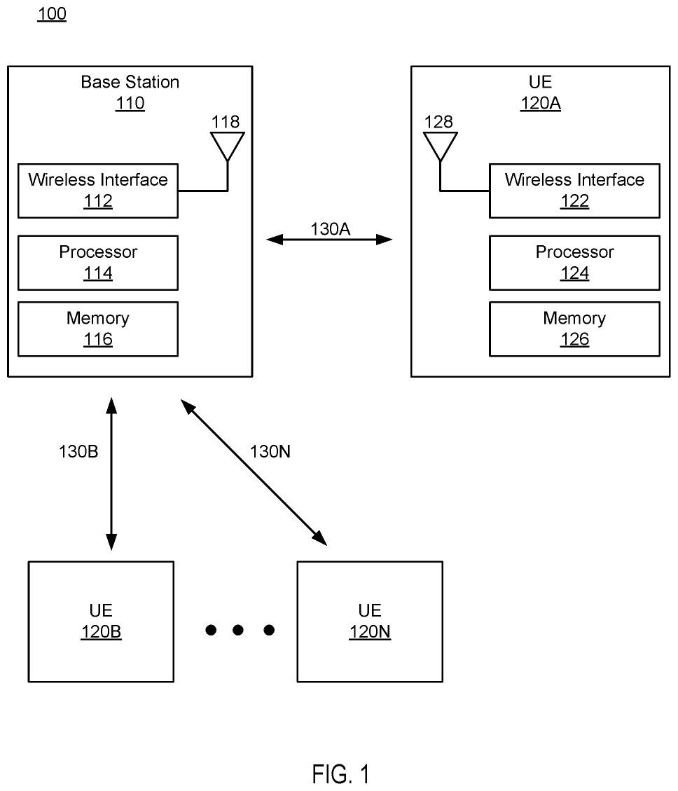

FIG. 1 illustrates an example wireless communication system 100. The wireless communication system 100 may include a base station 110 (also referred to as “a wireless communication node 110” or “a station 110”) and one or more user equipment (UEs) 120 (also referred to as “wireless communication devices 120” or “terminal devices 120”). The base station 110 and the UEs 120 may communicate through wireless commination links 130A, 130B, 130C. The wireless communication link 130 may be a cellular communication link conforming to 3G, 4G, 5G or other cellular communication protocols or a Wi-Fi communication protocol. In one example, the wireless communication link 130 supports, employs or is based on an orthogonal frequency division multiple access (OFDMA). In one aspect, the UEs 120 are located within a geographical boundary with respect to the base station 110, and may communicate with or through the base station 110. In some embodiments, the wireless communication system 100 includes more, fewer, or different components than shown in FIG. 1. For example, the wireless communication system 100 may include one or more additional base stations 110 than shown in FIG. 1.

In some embodiments, the UE 120 may be a user device such as a mobile phone, a smart phone, a personal digital assistant (PDA), tablet, laptop computer, wearable computing device, etc. Each UE 120 may communicate with the base station 110 through a corresponding communication link 130. For example, the UE 120 may transmit data to a base station 110 through a wireless communication link 130, and receive data from the base station 110 through the wireless communication link 130. Example data may include audio data, image data, text, etc. Communication or transmission of data by the UE 120 to the base station 110 may be referred to as an uplink communication. Communication or reception of data by the UE 120 from the base station 110 may be referred to as a downlink communication. In some embodiments, the UE 120A includes a wireless interface 122, a processor 124, a memory device 126, and one or more antennas 128. These components may be embodied as hardware, software, firmware, or a combination thereof. In some embodiments, the UE 120A includes more, fewer, or different components than shown in FIG. 1. For example, the UE 120 may include an electronic display and/or an input device. For example, the UE 120 may include additional antennas 128 and wireless interfaces 122 than shown in FIG. 1.

The antenna 128 may be a component that receives a radio frequency (RF) signal and/or transmit a RF signal through a wireless medium. The RF signal may be at a frequency between 200 MHz to 100 GHz. The RF signal may have packets, symbols, or frames corresponding to data for communication. The antenna 128 may be a dipole antenna, a patch antenna, a ring antenna, or any suitable antenna for wireless communication. In one aspect, a single antenna 128 is utilized for both transmitting the RF signal and receiving the RF signal. In one aspect, different antennas 128 are utilized for transmitting the RF signal and receiving the RF signal. In one aspect, multiple antennas 128 are utilized to support multiple-in, multiple-out (MIMO) communication.

The wireless interface 122 includes or is embodied as a transceiver for transmitting and receiving RF signals through a wireless medium. The wireless interface 122 may communicate with a wireless interface 112 of the base station 110 through a wireless communication link 130A. In one configuration, the wireless interface 122 is coupled to one or more antennas 128. In one aspect, the wireless interface 122 may receive the RF signal at the RF frequency received through antenna 128, and downconvert the RF signal to a baseband frequency (e.g., 0˜1 GHz). The wireless interface 122 may provide the downconverted signal to the processor 124. In one aspect, the wireless interface 122 may receive a baseband signal for transmission at a baseband frequency from the processor 124, and upconvert the baseband signal to generate a RF signal. The wireless interface 122 may transmit the RF signal through the antenna 128.

The processor 124 is a component that processes data. The processor 124 may be embodied as field programmable gate array (FPGA), application specific integrated circuit (ASIC), a logic circuit, etc. The processor 124 may obtain instructions from the memory device 126, and executes the instructions. In one aspect, the processor 124 may receive downconverted data at the baseband frequency from the wireless interface 122, and decode or process the downconverted data. For example, the processor 124 may generate audio data or image data according to the downconverted data, and present an audio indicated by the audio data and/or an image indicated by the image data to a user of the UE 120A. In one aspect, the processor 124 may generate or obtain data for transmission at the baseband frequency, and encode or process the data. For example, the processor 124 may encode or process image data or audio data at the baseband frequency, and provide the encoded or processed data to the wireless interface 122 for transmission.

The memory device 126 is a component that stores data. The memory device 126 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 126 may be embodied as a non-transitory computer readable medium storing instructions executable by the processor 124 to perform various functions of the UE 120A disclosed herein. In some embodiments, the memory device 126 and the processor 124 are integrated as a single component.

In some embodiments, each of the UEs 120B . . . 120N includes similar components of the UE 120A to communicate with the base station 110. Thus, detailed description of duplicated portion thereof is omitted herein for the sake of brevity.

In some embodiments, the base station 110 may be an evolved node B (eNB), a serving eNB, a target eNB, a femto station, or a pico station. The base station 110 may be communicatively coupled to another base station 110 or other communication devices through a wireless communication link and/or a wired communication link. The base station 110 may receive data (or a RF signal) in an uplink communication from a UE 120. Additionally or alternatively, the base station 110 may provide data to another UE 120, another base station, or another communication device. Hence, the base station 110 allows communication among UEs 120 associated with the base station 110, or other UEs associated with different base stations. In some embodiments, the base station 110 includes a wireless interface 112, a processor 114, a memory device 116, and one or more antennas 118. These components may be embodied as hardware, software, firmware, or a combination thereof. In some embodiments, the base station 110 includes more, fewer, or different components than shown in FIG. 1. For example, the base station 110 may include an electronic display and/or an input device. For example, the base station 110 may include additional antennas 118 and wireless interfaces 112 than shown in FIG. 1.

The antenna 118 may be a component that receives a radio frequency (RF) signal and/or transmit a RF signal through a wireless medium. The antenna 118 may be a dipole antenna, a patch antenna, a ring antenna, or any suitable antenna for wireless communication. In one aspect, a single antenna 118 is utilized for both transmitting the RF signal and receiving the RF signal. In one aspect, different antennas 118 are utilized for transmitting the RF signal and receiving the RF signal. In one aspect, multiple antennas 118 are utilized to support multiple-in, multiple-out (MIMO) communication.

The wireless interface 112 includes or is embodied as a transceiver for transmitting and receiving RF signals through a wireless medium. The wireless interface 112 may communicate with a wireless interface 122 of the UE 120 through a wireless communication link 130. In one configuration, the wireless interface 112 is coupled to one or more antennas 118. In one aspect, the wireless interface 112 may receive the RF signal at the RF frequency received through antenna 118, and downconvert the RF signal to a baseband frequency (e.g., 0˜1 GHz). The wireless interface 112 may provide the downconverted signal to the processor 124. In one aspect, the wireless interface 122 may receive a baseband signal for transmission at a baseband frequency from the processor 114, and upconvert the baseband signal to generate a RF signal. The wireless interface 112 may transmit the RF signal through the antenna 118.

The processor 114 is a component that processes data. The processor 114 may be embodied as FPGA, ASIC, a logic circuit, etc. The processor 114 may obtain instructions from the memory device 116, and executes the instructions. In one aspect, the processor 114 may receive downconverted data at the baseband frequency from the wireless interface 112, and decode or process the downconverted data. For example, the processor 114 may generate audio data or image data according to the downconverted data. In one aspect, the processor 114 may generate or obtain data for transmission at the baseband frequency, and encode or process the data. For example, the processor 114 may encode or process image data or audio data at the baseband frequency, and provide the encoded or processed data to the wireless interface 112 for transmission. In one aspect, the processor 114 may set, assign, schedule, or allocate communication resources for different UEs 120. For example, the processor 114 may set different modulation schemes, time slots, channels, frequency bands, etc. for UEs 120 to avoid interference. The processor 114 may generate data (or UL CGs) indicating configuration of communication resources, and provide the data (or UL CGs) to the wireless interface 112 for transmission to the UEs 120.

The memory device 116 is a component that stores data. The memory device 116 may be embodied as RAM, flash memory, ROM, EPROM, EEPROM, registers, a hard disk, a removable disk, a CD-ROM, or any device capable for storing data. The memory device 116 may be embodied as a non-transitory computer readable medium storing instructions executable by the processor 114 to perform various functions of the base station 110 disclosed herein. In some embodiments, the memory device 116 and the processor 114 are integrated as a single component.

In some embodiments, communication between the base station 110 and the UE 120 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

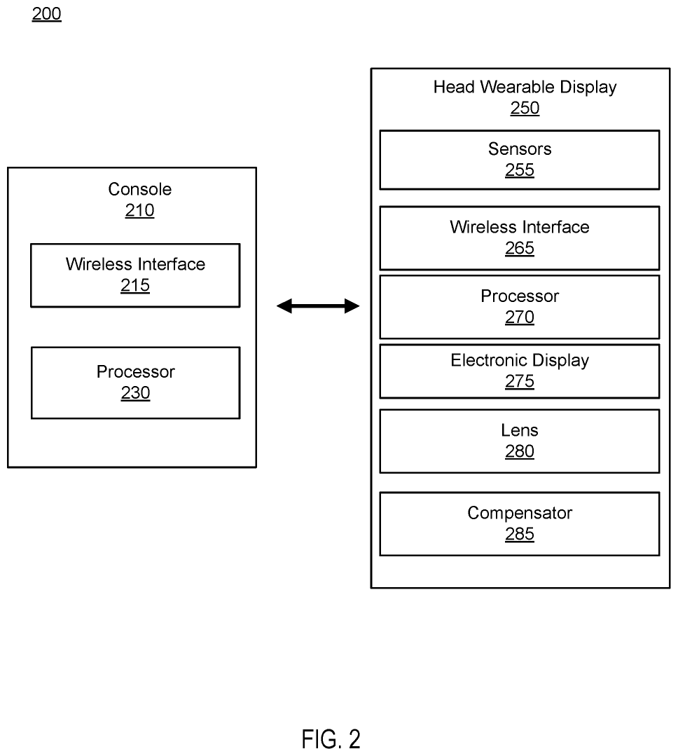

FIG. 2 is a block diagram of an example artificial reality system environment 200. In some embodiments, the artificial reality system environment 200 includes a HWD 250 worn by a user, and a console 210 providing content of artificial reality (e.g., augmented reality, virtual reality, mixed reality) to the HWD 250. Each of the HWD 250 and the console 210 may be a separate UE 120. The HWD 250 may be referred to as, include, or be part of a head mounted display (HMD), head mounted device (HMD), head wearable device (HWD), head worn display (HWD) or head worn device (HWD). The HWD 250 may detect its location and/or orientation of the HWD 250 as well as a shape, location, and/or an orientation of the body/hand/face of the user, and provide the detected location/or orientation of the HWD 250 and/or tracking information indicating the shape, location, and/or orientation of the body/hand/face to the console 210. The console 210 may generate image data indicating an image of the artificial reality according to the detected location and/or orientation of the HWD 250, the detected shape, location and/or orientation of the body/hand/face of the user, and/or a user input for the artificial reality, and transmit the image data to the HWD 250 for presentation. In some embodiments, the artificial reality system environment 200 includes more, fewer, or different components than shown in FIG. 2. In some embodiments, functionality of one or more components of the artificial reality system environment 200 can be distributed among the components in a different manner than is described here. For example, some of the functionality of the console 210 may be performed by the HWD 250. For example, some of the functionality of the HWD 250 may be performed by the console 210. In some embodiments, the console 210 is integrated as part of the HWD 250.

In some embodiments, the HWD 250 is an electronic component that can be worn by a user and can present or provide an artificial reality experience to the user. The HWD 250 may render one or more images, video, audio, or some combination thereof to provide the artificial reality experience to the user. In some embodiments, audio is presented via an external device (e.g., speakers and/or headphones) that receives audio information from the HWD 250, the console 210, or both, and presents audio based on the audio information. In some embodiments, the HWD 250 includes sensors 255, a wireless interface 265, a processor 270, an electronic display 275, a lens 280, and a compensator 285. These components may operate together to detect a location of the HWD 250 and a gaze direction of the user wearing the HWD 250, and render an image of a view within the artificial reality corresponding to the detected location and/or orientation of the HWD 250. In other embodiments, the HWD 250 includes more, fewer, or different components than shown in FIG. 2.

In some embodiments, the sensors 255 include electronic components or a combination of electronic components and software components that detect a location and an orientation of the HWD 250. Examples of the sensors 255 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 255 detect the translational movement and the rotational movement, and determine an orientation and location of the HWD 250. In one aspect, the sensors 255 can detect the translational movement and the rotational movement with respect to a previous orientation and location of the HWD 250, and determine a new orientation and/or location of the HWD 250 by accumulating or integrating the detected translational movement and/or the rotational movement. Assuming for an example that the HWD 250 is oriented in a direction 25 degrees from a reference direction, in response to detecting that the HWD 250 has rotated 20 degrees, the sensors 255 may determine that the HWD 250 now faces or is oriented in a direction 45 degrees from the reference direction. Assuming for another example that the HWD 250 was located two feet away from a reference point in a first direction, in response to detecting that the HWD 250 has moved three feet in a second direction, the sensors 255 may determine that the HWD 250 is now located at a vector multiplication of the two feet in the first direction and the three feet in the second direction.

In some embodiments, the sensors 255 include eye trackers. The eye trackers may include electronic components or a combination of electronic components and software components that determine a gaze direction of the user of the HWD 250. In some embodiments, the HWD 250, the console 210 or a combination of them may incorporate the gaze direction of the user of the HWD 250 to generate image data for artificial reality. In some embodiments, the eye trackers include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 250, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 250. In some embodiments, the eye trackers incorporate the orientation of the HWD 250 and the relative gaze direction with respect to the HWD 250 to determine a gate direction of the user. Assuming for an example that the HWD 250 is oriented at a direction 30 degrees from a reference direction, and the relative gaze direction of the HWD 250 is −10 degrees (or 350 degrees) with respect to the HWD 250, the eye trackers may determine that the gaze direction of the user is 20 degrees from the reference direction. In some embodiments, a user of the HWD 250 can configure the HWD 250 (e.g., via user settings) to enable or disable the eye trackers. In some embodiments, a user of the HWD 250 is prompted to enable or disable the eye trackers.

In some embodiments, the wireless interface 265 includes an electronic component or a combination of an electronic component and a software component that communicates with the console 210. The wireless interface 265 may be or correspond to the wireless interface 122. The wireless interface 265 may communicate with a wireless interface 215 of the console 210 through a wireless communication link through the base station 110. Through the communication link, the wireless interface 265 may transmit to the console 210 data indicating the determined location and/or orientation of the HWD 250, and/or the determined gaze direction of the user. Moreover, through the communication link, the wireless interface 265 may receive from the console 210 image data indicating or corresponding to an image to be rendered and additional data associated with the image.

In some embodiments, the processor 270 includes an electronic component or a combination of an electronic component and a software component that generates one or more images for display, for example, according to a change in view of the space of the artificial reality. In some embodiments, the processor 270 is implemented as a part of the processor 124 or is communicatively coupled to the processor 124. In some embodiments, the processor 270 is implemented as a processor (or a graphical processing unit (GPU)) that executes instructions to perform various functions described herein. The processor 270 may receive, through the wireless interface 265, image data describing an image of artificial reality to be rendered and additional data associated with the image, and render the image to display through the electronic display 275. In some embodiments, the image data from the console 210 may be encoded, and the processor 270 may decode the image data to render the image. In some embodiments, the processor 270 receives, from the console 210 in additional data, object information indicating virtual objects in the artificial reality space and depth information indicating depth (or distances from the HWD 250) of the virtual objects. In one aspect, according to the image of the artificial reality, object information, depth information from the console 210, and/or updated sensor measurements from the sensors 255, the processor 270 may perform shading, reprojection, and/or blending to update the image of the artificial reality to correspond to the updated location and/or orientation of the HWD 250. Assuming that a user rotated his head after the initial sensor measurements, rather than recreating the entire image responsive to the updated sensor measurements, the processor 270 may generate a small portion (e.g., 10%) of an image corresponding to an updated view within the artificial reality according to the updated sensor measurements, and append the portion to the image in the image data from the console 210 through reprojection. The processor 270 may perform shading and/or blending on the appended edges. Hence, without recreating the image of the artificial reality according to the updated sensor measurements, the processor 270 can generate the image of the artificial reality.

In some embodiments, the electronic display 275 is an electronic component that displays an image. The electronic display 275 may, for example, be a liquid crystal display or an organic light emitting diode display. The electronic display 275 may be a transparent display that allows the user to see through. In some embodiments, when the HWD 250 is worn by a user, the electronic display 275 is located proximate (e.g., less than 3 inches) to the user's eyes. In one aspect, the electronic display 275 emits or projects light towards the user's eyes according to image generated by the processor 270.

In some embodiments, the lens 280 is a mechanical component that alters received light from the electronic display 275. The lens 280 may magnify the light from the electronic display 275, and correct for optical error associated with the light. The lens 280 may be a Fresnel lens, a convex lens, a concave lens, a filter, or any suitable optical component that alters the light from the electronic display 275. Through the lens 280, light from the electronic display 275 can reach the pupils, such that the user can see the image displayed by the electronic display 275, despite the close proximity of the electronic display 275 to the eyes.

In some embodiments, the compensator 285 includes an electronic component or a combination of an electronic component and a software component that performs compensation to compensate for any distortions or aberrations. In one aspect, the lens 280 introduces optical aberrations such as a chromatic aberration, a pin-cushion distortion, barrel distortion, etc. The compensator 285 may determine a compensation (e.g., predistortion) to apply to the image to be rendered from the processor 270 to compensate for the distortions caused by the lens 280, and apply the determined compensation to the image from the processor 270. The compensator 285 may provide the predistorted image to the electronic display 275.

In some embodiments, the console 210 is an electronic component or a combination of an electronic component and a software component that provides content to be rendered to the HWD 250. In one aspect, the console 210 includes a wireless interface 215 and a processor 230. These components may operate together to determine a view (e.g., a FOV of the user) of the artificial reality corresponding to the location of the HWD 250 and the gaze direction of the user of the HWD 250, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 250 in a physical space into a virtual space (or simultaneous localization and mapping (SLAM) data), eye tracking data, motion vector information, depth information, edge information, object information, etc. The console 210 may provide the image data and the additional data to the HWD 250 for presentation of the artificial reality. In other embodiments, the console 210 includes more, fewer, or different components than shown in FIG. 2. In some embodiments, the console 210 is integrated as part of the HWD 250.

In some embodiments, the wireless interface 215 is an electronic component or a combination of an electronic component and a software component that communicates with the HWD 250. The wireless interface 215 may be or correspond to the wireless interface 122. The wireless interface 215 may be a counterpart component to the wireless interface 265 to communicate through a communication link (e.g., wireless communication link). Through the communication link, the wireless interface 215 may receive from the HWD 250 data indicating the determined location and/or orientation of the HWD 250, and/or the determined gaze direction of the user. Moreover, through the communication link, the wireless interface 215 may transmit to the HWD 250 image data describing an image to be rendered and additional data associated with the image of the artificial reality.

The processor 230 can include or correspond to a component that generates content to be rendered according to the location and/or orientation of the HWD 250. In some embodiments, the processor 230 is implemented as a part of the processor 124 or is communicatively coupled to the processor 124. In some embodiments, the processor 230 may incorporate the gaze direction of the user of the HWD 250. In one aspect, the processor 230 determines a view of the artificial reality according to the location and/or orientation of the HWD 250. For example, the processor 230 maps the location of the HWD 250 in a physical space to a location within an artificial reality space, and determines a view of the artificial reality space along a direction corresponding to the mapped orientation from the mapped location in the artificial reality space. The processor 230 may generate image data describing an image of the determined view of the artificial reality space, and transmit the image data to the HWD 250 through the wireless interface 215. In some embodiments, the processor 230 may generate additional data including motion vector information, depth information, edge information, object information, hand model data, etc., associated with the image, and transmit the additional data together with the image data to the HWD 250 through the wireless interface 215. The processor 230 may encode the image data describing the image, and can transmit the encoded data to the HWD 250. In some embodiments, the processor 230 generates and provides the image data to the HWD 250 periodically (e.g., every 11 ms).

In one aspect, the process of detecting the location of the HWD 250 and the gaze direction of the user wearing the HWD 250, and rendering the image to the user should be performed within a frame time (e.g., 11 ms or 16 ms). A latency between a movement of the user wearing the HWD 250 and an image displayed corresponding to the user movement can cause judder, which may result in motion sickness and can degrade the user experience. In one aspect, the HWD 250 and the console 210 can prioritize communication for AR/VR, such that the latency between the movement of the user wearing the HWD 250 and the image displayed corresponding to the user movement can be presented within the frame time (e.g., 11 ms or 16 ms) to provide a seamless experience.

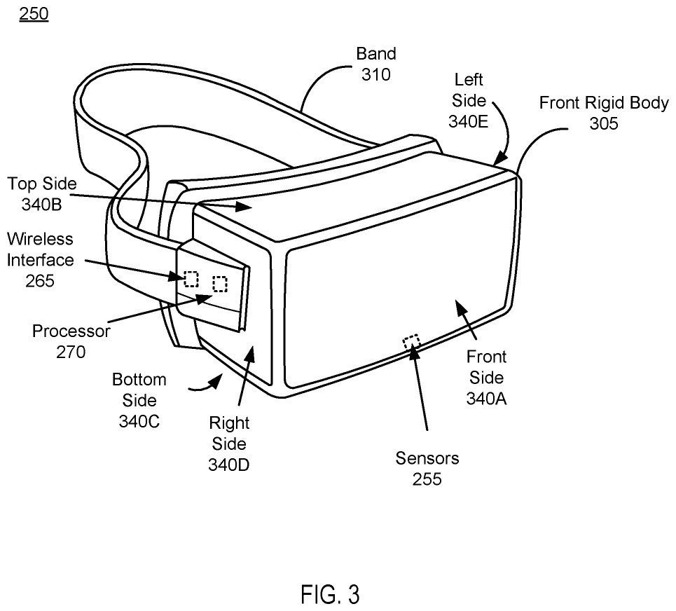

FIG. 3 is a diagram of a HWD 250, in accordance with an example embodiment. In some embodiments, the HWD 250 includes a front rigid body 305 and a band 310. The front rigid body 305 includes the electronic display 275 (not shown in FIG. 3), the lens 280 (not shown in FIG. 3), the sensors 255, the wireless interface 265, and the processor 270. In the embodiment shown by FIG. 3, the wireless interface 265, the processor 270, and the sensors 255 are located within the front rigid body 205, and may not be visible externally. In other embodiments, the HWD 250 has a different configuration than shown in FIG. 3. For example, the wireless interface 265, the processor 270, and/or the sensors 255 may be in different locations than shown in FIG. 3.

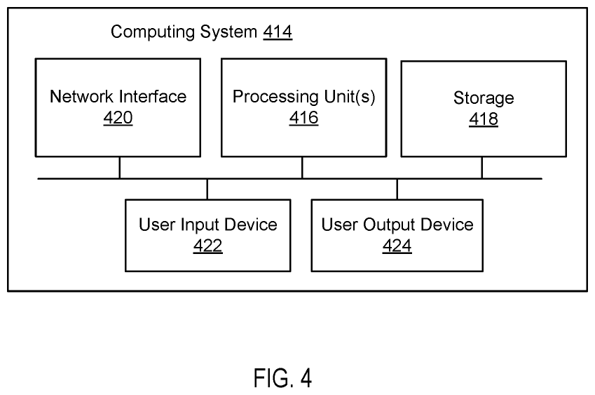

Various operations described herein can be implemented on computer systems. FIG. 4 shows a block diagram of a representative computing system 414 usable to implement the present disclosure. In some embodiments, the source devices 110, the sink device 120, the console 210, the HWD 250 are implemented by the computing system 414. Computing system 414 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 414 can be implemented to provide VR, AR, MR experience. In some embodiments, the computing system 414 can include conventional computer components such as processors 416, storage device 418, network interface 420, user input device 422, and user output device 424.

Network interface 420 can provide a connection to a wide area network (e.g., the Internet) to which WAN interface of a remote server system is also connected. Network interface 420 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 420 may include a transceiver to allow the computing system 414 to transmit and receive data from a remote device using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 416. Similarly, a receiver may be configured to receive frames, slots or symbols and the processor unit 416 may be configured to process the frames. For example, the processor unit 416 can be configured to determine a type of frame and to process the frame and/or fields of the frame accordingly.

User input device 422 can include any device (or devices) via which a user can provide signals to computing system 414; computing system 414 can interpret the signals as indicative of particular user requests or information. User input device 422 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 424 can include any device via which computing system 414 can provide information to a user. For example, user output device 424 can include a display to display images generated by or delivered to computing system 414. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 424 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 416 can provide various functionality for computing system 414, including any of the functionality described herein as being performed by a server or client, or other functionality associated with message management services.

It will be appreciated that computing system 414 is illustrative and that variations and modifications are possible. Computer systems used in connection with the present disclosure can have other capabilities not specifically described here. Further, while computing system 414 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

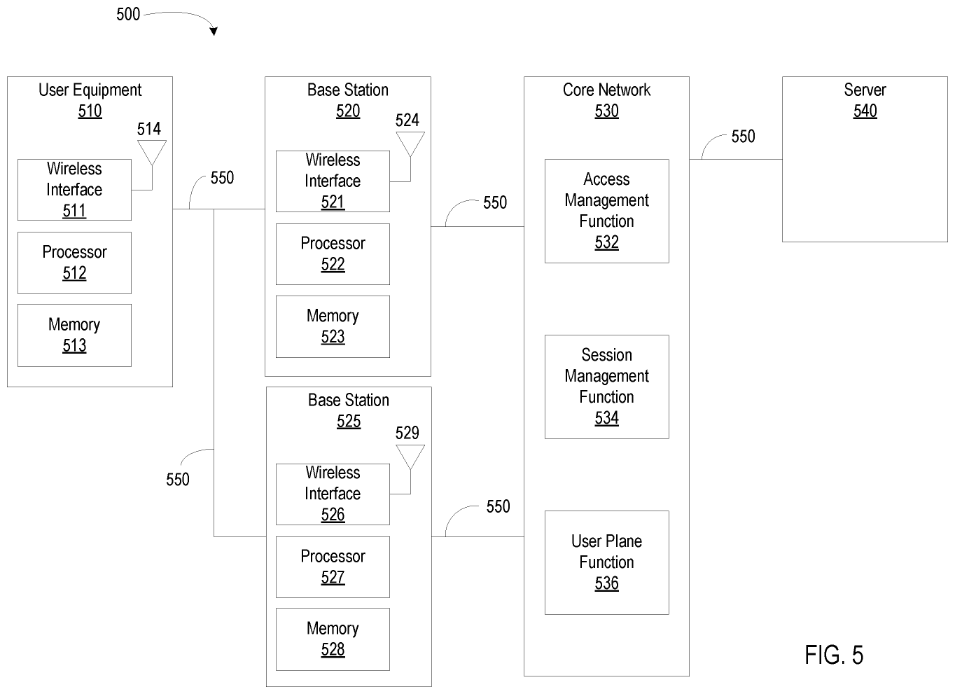

Referring now to FIG. 5, a wireless communication system 500 is shown. The wireless communication system 500 may include one or more user equipment (UE) 510, one or more base stations 520 and 525, a core network 530, and a server 540. The UEs 510, the base stations 520, 525, the core network 530, and the server 540 may communicate through wireless commination links. The wireless communication link 550 may be a cellular communication link conforming to 3G, 4G, 5G or other cellular (or radio frequency [RF]) communication protocols. In one example, the wireless communication link 550 supports, employs or is based on an orthogonal frequency division multiple access (OFDMA). In one aspect, the UEs 510 are located within a geographical boundary or service area with respect to the base stations 520, 525. In this regard, the UEs 510 may be configured to communicate with or through the respective base stations 520, 525 (e.g., in closest proximity to the UE 510, having a greatest signal strength, and so forth). In some embodiments, the wireless communication system 500 includes more, fewer, or different components than shown in FIG. 5. For example, the wireless communication system 500 may include one or more additional base stations 520, 525 than shown in FIG. 5.

In some embodiments, the UE 510 includes a wireless interface 511, a processor 512, a memory device 513, and one or more antennas 514. These components may be embodied as hardware, software, firmware, or a combination thereof. In some embodiments, the UE 510 may be similar to the UE 120 described with respect to FIG. 1. The UE 510 may also be referred to as a wireless communication device and/or a device.

In some embodiments, the base station 520 includes a wireless interface 521, a processor 522, a memory device 523, and one or more antennas 524. In some embodiments, the base station 525 includes a wireless interface 526, a processor 527, a memory device 528, and one or more antennas 529. These components may be embodied as hardware, software, firmware, or a combination thereof. In some embodiments, the base stations 520, 525 may be similar to the base station 110 described with respect to FIG. 1. In some embodiments, the base station 520 may be similar to the base station 525 and perform similar processes. One or more of the base stations may be, for example a wireless communication node. One or more of the base stations may be a gNodeB (gNB) of a cellular network.

The system 500 may include a core network 530. The core network 530 may be or include any device, component, element, or hardware designed to establish a reliable and secure network connectivity for end users. The core network 530 may be used for data or information communication over distances and in various contexts (such as voice or data routing, connection to external networks, and so forth). In some embodiments, the core network 530 may include an access management function 532, a session management function 534, and/or a user plane function 536. These functions are described in greater detail below. The core network 530 may include additional functions. For example, the core network 530 may include a network exposure function (NEF), a policy control function (PCF), and/or an authentication server function (ASF).

The core network 530 may include an access management function (AMF) 532. The AMF 532 may manage a registration of one or more devices in a network and establish connections for the devices. For example, the AMF 532 may establish a connection for a UE 510. The AMF 532 may also authenticate and/or authorize the UE 510, help maintain mobility of a UE 510 within the network, and/or provide uninterrupted access to network services.

The core network 530 may include a session management function (SMF) 534. The SMF may handle an establishment of a session, a modification of a session, and/or a release of a session between the UE 510 and the network and/or a server (e.g., server 540). The SMF 534 may manage one or more data flow paths and/or allocate network resources for one or more sessions. In some embodiments, the SMF 534 may be involved in IP address allocation and manage a Quality of Service (QOS).

The core network 530 may include a user plane function (UPF) 536. The UPF 536 may be involved in handling user data traffic. The UPF 536 may route and/or forward data packets from a UE 510 to a data network and vice versa. The UPF 536 may also enforce traffic policies, charge for data usage, and/or provide data buffering for mobility support.

The various functions and components of the core network 530 and system 500 may be configured to communicate with one another via various interfaces or protocols. For example, some wireless communication nodes may communicate with other wireless communication nodes via the Xn interface (e.g., the interface between two gNodeBs) using the Xn application protocol (XnAP). As another example, a wireless communication node may be configured to communicate with the AMF 532 via the N2 interface using the next generation application protocol (NGAP). While these two examples are described, other interfaces and protocols may be used for communicating between any one component of the system 500 and any other component of the system 500.

The system 500 may include a server 540. The server 540 may store, send, and/or receive data. The server 540 may host or otherwise execute various applications or resources which may be accessed via the core network 530 by a UE 510. For example, the server 540 may be configured to host an augmented reality (AR), virtual reality (VR), or extended reality (XR) application or resource, which may provide content via the core network 530 to a UE 510. While this example is provided, it is noted that many other applications or resources may be hosted or executed on the server 540 and accessed by the UE 510. Similarly, while one server 540 is shown in FIG. 5, any number of servers 540 may be included in the system 500.

The present disclosure is directed to systems and methods for a cellular device/wireless communication device (e.g., UE 510) to determine whether a wireless communication node (e.g., a base station 520, 525) supports low queuing latency, low loss, and scalable throughput (L4S) protocols. In general, an L4S protocol may facilitate a network device or component signaling to a sender or source of an internet protocol (IP) flow, a potential congestion status of the network. A network device or component implementing or using the L4S protocol may proactively indicate to an endpoint that a data pipe is congested and communicate to a sender that a sending rate should be decreased. The congestion status may be signaled using an explicit congestion notification (ECN) marking at the IP network layer. The sender may therefore be configured to adjust its sending rate responsive to receiving the signal that the network is congested. For example, the sender may decrease a sending rate responsive to a signal that the network is congested. Adjusting a sending rate by the sender may avoid a queueing delay buildup within the network. In various embodiments, the queueing delay buildup may be a source of transport network latency. For example, if the sender is aware of a potential congestion level in the network, the sender may shape the network traffic before any buffer-bloat occurs. Accordingly, an overall transmission delay may be minimized (e.g., less retransmission) and transmission link utilization may be optimal. The congestion signal sent to the sender may be based on ECN marking for L4S flows.

In various embodiments, ECN marking may be performed by the wireless communication node (e.g., base station 520, 525) or at the UPF 536 with congestion information sent by the wireless communication node 520, 525. In various embodiments, if congestion marking is performed by the UPF 536, the wireless communication node 520, 525 may support performing the L4S related tasks by informing the congestion level to the UPF 536. For example, the base station 520, 525 or the UPF 536 may signal to the UE 510 that a congestion of the network is upcoming. Based on the signal, the UE 510 may indicate to the sender (e.g., an application) that the sending rate should decrease. The UE 510 may signal to the application to slow a bit transmission responsive to receiving a congestion signal via a feedback mechanism. For example, the UE 510 may use Layer 4 feedback, the Transmission Control Protocol (TCP), and/or the QUIC protocol to indicate to the application that the UE 510 is receiving a congestion indication. In response, the application may lower the sending rate. In various embodiments, an uplink (e.g., application to UE 510) communication process may be similar to the downlink (e.g., UE 510 to application) process described herein. The application or sender may slow a bitstream or data transmission rate to accommodate congestion until it receives feedback from the UE 510 indicating that there is no longer network congestion.

In various embodiments, L4S may not be supported or available across the network. If congestion marking is performed once and the UE 510 is static (e.g., there is no mobility event and a connection path remains the same), congestion marking may be performed any time congestion occurs and the UE 510 may receive a signal indication congestion. In embodiments where L4S is not supported, the UE 510 may initiate a user plane (UP) connection with end-to-end (E2E) L4S supported. However, due to the mobility of the UE 510, the UE 510 may be located near and connected to a wireless communication node 520, 525 which does not support L4S protocols, and thus the connection may end up as a non-E2E L4S UP connection.

In a mobile network, mobility events may occur often, and the UE 510 may often move from a first wireless node 520, 525 to a second wireless node 520, 525, to a third wireless node 520, 525, and so forth. In various embodiments, the UE 510 may move from a wireless node 520, 525 where UPF 536 that supports congestion marking (e.g., an L4S protocol used for congestion marking) to a wireless node 520, 525 where UPF 536 that does not support congestion marking. Therefore, if a UE 510 receives a signal indicating congestion marking at the beginning of a data session, the UE 510 may not receive a signal indicating congestion marking after a mobility event.

In various embodiments, the UE 510 may determine if congestion marking is or is not enabled after a mobility event if the L4S protocol is not supported at the wireless node. Additional processing may occur (e.g., by processor 512) to determine if congestion marking occurs at a given wireless node 520, 525. Therefore, it may be beneficial for the UE 510 to receive an indication that a wireless node that the UE is currently connected to supports L4S (e.g., the wireless communication node or UPF 536 is capable of providing an ECN/congestion marking).

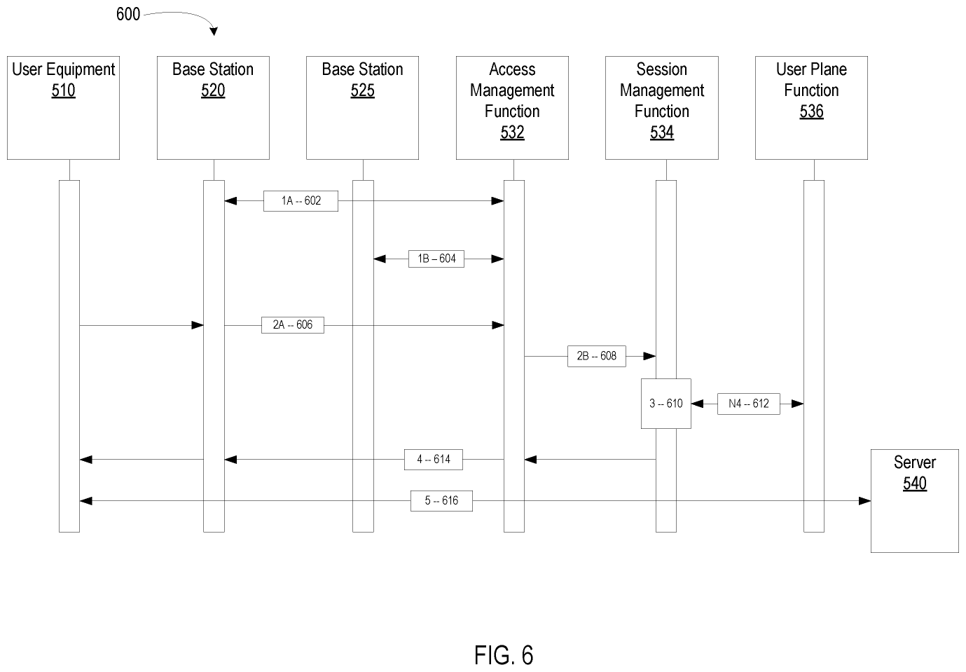

Referring now to FIG. 6, a process flow 600 illustrating a wireless communication device determining an L4S support status is shown, according to an exemplary embodiment. The process flow 600 is shown to include various component or elements, which may be similar to or the same as the components of the system 500 described with respect to FIG. 5. The components of the process flow 600 may be in communication with each other through a variety of pathways/networking connections/interfaces.

In various embodiments, the AMF 532 may receive data from one or more of the base stations 520, 525 indicating whether or not the base station supports L4S. Process 602 may indicate a configuration data exchange between the first base station 520 and the AMF 532. For example, in various embodiments, the first base station 520 may support the L4S protocol. The configuration data exchange between the first base station 520 and the AMF 532 may contain or include data indicating that the first base station supports L4S. Similarly, process 604 may indicate a configuration data exchange between the second base station 525 and the AMF 532. For example, in various embodiments, the second base station 525 may not support L4S. The configuration data exchange between the second base station 525 and the AMF 532 may contain data indicating that the second base station does not support L4S.

In various embodiments, in addition to indicating L4S support, the base stations 520, 525 may communicate information related to L4S architecture options of the base station. In various embodiments, the base station 520, 525 may indicate L4S support and/or architecture options for various procedures. For example, the base station 520, 525 may indicate the information for a N2-interface next generation application protocol (NGAP) connection setup procedure. In various embodiments, the N2-interface GAP connection setup procedure may be a type of N2 configuration update procedure. The AMF 532 may store, maintain, or otherwise access information regarding the L4S support capabilities of the base station 520, 525. In various embodiments, at the AMF 532, L4S support may be at an AMF set level.

In various embodiments, the UE 510 may request to establish a session to connect to the server 540 (e.g., begin a data session) (e.g., at process 606, the UE 510 sends the request to the base station 520 and the AMF 532 to establish the connection between the UE 510 and the server 540 shown at process 616). For example, the UE 510 may request to establish a session to connect with the server 540, responsive to accessing a resource or application hosted by the server, responsive to a user accessing a local instance of the resource (e.g., on the UE 510), responsive to requesting data to be retrieved from the server 540, and so forth. The UE 510 may send the request to the base station 520, which may forward the request to the AMF 532, as shown at process 606. The AMF 532 may facilitate establishing the connection between the UE 510 and the server 540. In various embodiments, the data session may be a Protocol Data Unit (PDU) session.

In various embodiments, some base stations 520, 525 may support L4S, and some base stations 520, 525 may not. For example, a first base station 520 may support the L4S protocol while a second base station 525 may not support the L4S protocol. The UE 510 may communicate with a first base station 520 that includes a dedicated IP flow for the L4S protocol (e.g., L4S is supported). After a mobility event, the UE 510 may switch to communicate with a second base station 525 that does not include or support a dedicated IP flow for the L4S protocol. If the L4S protocol is not supported by a base station, there may be an increase in latency (e.g., congestion in a data flow) and the UE 510 may not determine a cause of the latency. An increased level of processing may lead to a longer time to determine if L4S is supported and may be inefficient.

As described in greater detail below, the UE 510 may be configured to efficiently determine if L4S protocol is supported by a base station 520, 525 in various different ways. For example, the UE 510 may be configured to determine whether the L4S protocol is supported by a base station through implicit detection, through a per-node level capability exchange and/or based on a registration area notification. In such embodiments, the UE 510 may be configured to quickly adapt to changes in network configuration (e.g., based on the mobility event), and thereby reduce causes of latency by managing congestion at the respective endpoints.

In various embodiments, when a data session between the UE 510 and a base station 520, 525 is established (e.g., as shown by process 606), the network may know if L4S is supported by the base station 520, 525. In various embodiments, L4S support may involve and/or include a dedicated L4S quality of service (QOS) IP flow in the PDU session. One or more of the UE 510 and application server 540 may generate an explicit request for L4S support for the session. Process 606 indicates a request by the UE 510 to the AMF 532 to connect with the base station 520. In various embodiments, an application executing on the UE 510 may generate the request for L4S support. Establishing the dedicated L4S QoS flow end-to-end (E2E) may be indicative that L4S may be supported for the PDU session. In various embodiments, one or more of the UE 510 and/or the server 540 may perform L4S validation to determine if L4S is supported end-to-end (E2E). The L4S validation may be performed using an application procedure. If the dedicated L4S QoS flow cannot be established E2E, it may be indicative that L4S may not be supported for the PDU session.

After a mobility event, the UE 510 may determine a status of the IP flow for the L4S protocol at the second base station 525. If the UE 510 determines an active status of the IP flow, the UE 510 may subsequently determine that the L4S protocol is supported by the second base station 525 based on the active status. If the IP flow has an active status, the UE 510 may receive a packet on the IP flow. The packet may include an ECN notification or marking, indicating information about an upcoming congestion. If the UE 510 determines an inactive status of the IP flow, the UE 510 may subsequently determine that the L4S protocol is not supported by the second base station 525 based on the inactive status. If the IP flow has an inactive status, the UE 510 may not receive an ECN notification and may not receive information about an upcoming congestion.

In various embodiments, one or more of the UE 510 and/or the application server 540 may request L4S service for an IP flow to a cellular network. In various embodiments, the UE 510 may implicitly determine if L4S service is supported by the base station 520, 525, based on whether the IP flow for supporting the L4S service is established, as described in greater detail below.

If the dedicated L4S QoS flow can be established by the network, various networking intermediaries (such as the wireless communication nodes 520, 525) may be configured to use the L4S protocol to provide ECN notifications via the dedicated L4S QOS flow uplink or downlink to a corresponding endpoint. If L4S is supported, a sender may receive an ECN marking or other notification indicating that a delay may occur soon. For example, the sender may receive a notification that a buffer is about to be filled, and a delay may occur when the buffer is filled. In response, the sender can proactively lower the sending rate to prevent a delay. In various embodiments, the L4S protocol may facilitate a scalable congestion control solution implementable by the wireless communication components described herein. In various embodiments, the UE 510 and/or the server 540 may receive an indication that L4S may be supported by the network at the beginning of the PDU session. This may be a result of the explicit request by the UE 510 and/or the server 540 or an indication received from the network by the UE 510 and/or the server 540.

If the network cannot establish the dedicated L4S QoS flow (e.g., setup is unsuccessful and/or rejected by the network), the UE 510 and/or the server 540 may use a different congestion control solution or protocol. If L4S is not supported, a delay may have already occurred in the system by the time the regarding UE 510 receives any packets or other related information which indicates that downlink congestion has been experienced. For example, the UE 510 may experience packet drops, increased retransmissions, increased buffer status, etc. As such, latency and effects of congestion may already occur, without the UE 510 being made aware of a lack of L4S support.

According to the systems and methods described herein, an acceptance or rejection of the L4S flow by the target base station may be an implicit detection by the UE 510 of whether the target base station supports the L4S protocol. In various embodiments, the target base station may be configured to support L4S or not support L4S (e.g., the target base station “knows” whether it supports the L4S protocol). A base station may not support the L4S protocol due to various factors such as hardware limitations, software incompatibility, cost constraints, regulatory issues, lack of market demand for low-latency services, and/or the complexity of integrating and managing L4S within the existing network infrastructure.

In various embodiments, a mobility event triggered by the UE 510 may include a connection management idle (CM_idle) mobility event. A CM_idle mobility event may indicate that no data is being transmitted between the UE 510 and the server 540 during the PDU session. If a CM_idle mobility event occurs, because there is no data flow between endpoints, congestion may not occur as a result. Therefore, a change in L4S support may not be detected since user plane resources may not be active during the in a CM_idle mobility event.

In various embodiments, there may be a connection management active (CM_active) mobility event and/or a radio resource control active(RRC_active) mobility event during the PDU session. CM_active mobility and/or RRC_active mobility may occur when a UE 510 moves from a first base station (e.g., base station 520) to a second base station (e.g., base station 525) during an active session (e.g., a session in which data is actively being communicated between the endpoints). For example, mobility may occur by the UE 510 between a source base station (e.g., base station 520) and a target base station (e.g., base station 525). The source may be the base station that the UE 510 is first in communication with (e.g., the base station which first serves the PDU session with the UE 510), and the target base station may be the base station that the UE 510 moves to establish a connection with (e.g., the base station which is to serve the PDU session with the UE 510 after the mobility event).

The PDU session established between the UE 510 and server 540 may include various QoS flows (or data pipes, bit pipes, data flows, etc.). Each QoS flow may be defined or established to include or carry a specific type of network traffic of the PDU session. For example, the QoS flows may include a low latency flow, high throughput data flow, a voice flow, a video call flow, a control plane flow, and so forth. Each QoS flow may be designed to carry specific information/data/traffic of the PDU session.

In various embodiments, L4S may be assigned to a dedicated QoS flow. If the source base station supports L4S, the source base station may support the dedicated L4S QoS flow. In various embodiments, the L4S QoS flow may be assigned an individual QoS flow through which data relating to the L4S QoS protocol is communicated. In various embodiments, a number of established QoS flows for a UE 510 may depend upon a number of applications running on the UE 510. In various embodiments, all of data QoS flows of a PDU session for a given UE 510 may move from the source base station to the target base station when a mobility event occurs. The target base station may communicate to the UE 510 which QoS flows are accepted and which are rejected. An admission by the target base station may indicate to the UE 510 whether the L4S QOS flow has been accepted or rejected. In various embodiments the UE 510 may know which QoS flows have been accepted by the target base station and which QoS flows have been rejected by the target base station. If the target base station accepts the L4S QOS flow for the source base station (e.g., base station 520), the acceptance of the L4S QoS flow may implicitly indicate to the network, and subsequently the UE 510, that the target base station supports the L4S protocol. On the other hand, if the target base station accepts each QoS flow except for the dedicated L4S QOS flow, the rejection (or non-acceptance) of the dedicated L4S QoS flow for the PDU session may implicitly indicate to the UE 510 that the target base station supports L4S protocol.

During a mobility event, the UE 510 may move from a service area of a first base station to a service area of a second base station (e.g., move from base station 520 to base station 525). More specifically, a mobility event may occur when the UE 510 moves from a service area of the source base station to a service area of the target base station (e.g., the UE 510 may not initiate a request at the target base station). During the mobility event, the plurality of QoS flows maintained at the source base station may transfer to the target base station to be maintained. During a mobility event, the target base station may accept or reject a handover of the L4S QoS flow. Responsive to the mobility event, the source base station may initiate a handover of the QoS flows to the target base station. In this regard, a handover may occur by transferring L4S QoS flow data from the source base station to the target base station (e.g., by the target base station accepting the L4S QoS flow from the source base station). In various embodiments, the target base station may determine that an incoming QoS flow may utilize L4S.

During the CM_active mobility and RRC_active mobility, if the target base station does support the L4S protocol, then the dedicated L4S QoS flow setup in the target cell may succeed. In various embodiments, the target base station accepting the handover of the L4S flow and/or success of the L4S QoS flow setup may be indicative that the target base station supports the L4S protocol. In various embodiments, a list of QoS flows that successfully set up in the target base station may be informed to the UE 510 via, for example, a handover command message. The UE 510 may receive an indication that L4S is supported, according to the handover command message (e.g., if the QoS flow for L4S is accepted by the target base station, then the UE 510 may be configured to determine that L4S is supported by the target base station based on such acceptance).

During the CM_active mobility event and RRC_active mobility event, if the target base station does not support the L4S protocol, then the dedicated L4S QoS flow setup in the target base station may fail. In various embodiments, the target base station rejecting the handover of the L4S flow or failure of the L4S QoS flow setup may be indicative that the target base station does not support the L4S protocol. The UE 510 may receive an indication that L4S is not supported. In various embodiments, after the handover, and if L4S QoS flow is not successfully set up in the target base station, the UE 510 may inform impacted applications. In various embodiments, if the target base station does not support the L4S protocol, one or more of the UE 510 and/or the base station 525 may utilize a congestion notification method that does not utilize the L4S protocol (e.g., repeatedly halving a data bandwidth). In various embodiments, a UE 510 application may inform an application on the application server 540 to utilize a different congestion notification method.

During one or more of a CM_inactive mobility and/or an RRC_inactive mobility, a radio resource may be suspended (e.g., there is no data flow). Therefore, L4S support may not be relevant (e.g., because no data flow is being exchanged to experience or cause congestion). In various embodiments, the UE 510 may transition to the CM_active mobility and/or the RRC_active mobility. The serving base station with respect to the UE 510 may change (e.g., base station 520 initially serves the UE 510, and base station 525 subsequently serves the UE 510). In various embodiments, the new base station 525 may not support the dedicated L4S QoS flow. The new base station 525 may release the dedicated L4S QoS flow and a corresponding radio bearer. This may be an indication to the UE 510 that L4S is not supported in the current base station 525, and the UE 510 may inform an upper (e.g., application) layer.

In various embodiments, an application of the UE 510 and/or application at the server 540 side may be configured to probe, signal, or otherwise request the network to set up or establish the dedicated L4S QoS flow. For example, the UE 510 and/or server 540 may be configured to probe the network, according to a known service agreement between an application provider and a carrier. The UE 510 and/or application server 540 may probe or request the network to establish the L4S QoS flow, by communicating or transmitting, for example, a control message, a frame, or an information element which requests establishing the L4S QoS flow. If the network does not support L4S the service area, then the network may provide a permanent failure cause code to the UE 510 in response to a request for L4S support by the UE 510. In various embodiments, a permanent failure cause code may indicate to the UE 510 and/or server 540 that L4S support is not available from the network and/or base station. For example, the UE 510 may probe a base station and/or network to determine if L4S is supported. If L4S is not supported, a permanent failure cause code may be delivered to the UE 510 indicating that L4S is not supported. A permanent failure cause code may prevent the user device from probing the same base station/network again, since it has been determined that L4S is not established.

In various embodiments, an application both on the device and/or at the server side may receive information relating to a QoS flow identifier (5QI). In various embodiments, the 5QI may be used for the dedicated L4S QoS. The 5QI may be used for the dedicated L4S QoS through one or more of a service agreement between the app provider and the carrier and/or through a cellular communication/protocol standardization. A 5QI may be an identifier, such as a number, that is sent from the network to the UE 510. The 5QI identifier may indicate whether a data pipe (or QoS flow) supports the L4S protocol. For example, if the UE 510 probes a network and receives a 5QI of 50 (or any other fixed/predetermined/set 5QI value), that certain 5QI value may indicate that the given data pipe supports L4S. In various embodiments, another 5QI value may be used to indicate that a data pipe supports L4S.

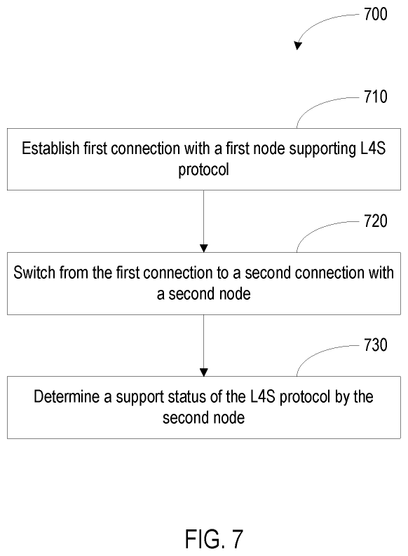

Referring now to FIG. 7, a flowchart of a method 700 is shown for determining a support status of an L4S protocol through implicit detection, according to an example embodiment of the present disclosure. The method 700 may be performed, executed by, or otherwise implemented by the devices, components, elements, or hardware described above with reference to FIG. 1-FIG. 6. As a brief overview, at step 710, a wireless communication device may establish a first connection with a first wireless communication node. At step 720, the wireless communication device may switch from the first connection to a second connection. At step 730, the wireless communication device may determine a support status of the L4S protocol by the second wireless communication node.

At process 710, a wireless communication device may establish a first connection with a first wireless communication node. For example, a wireless communication device, such as the UE 510, may establish a first connection with a first wireless communication node (such as the base station 520). The first connection may be or include a data session, such as a PDU session. In various embodiments, the first connection with the first communication node may include a dedicated IP flow for the L4S protocol. The wireless communication device may establish the first connection with the first wireless communication node, responsive to being in a service area of the first wireless communication node. The first wireless communication device may establish the first connection, to establish a session with an endpoint (such as a server). For example, the first wireless communication device may establish the session with the endpoint responsive to a user of the first wireless communication device accessing a resource hosted or served by the server, responsive to requesting data from the server, and so forth.

In some embodiments, step 710 may include requesting the dedicated IP flow for the L4S protocol for the first connection. For example, the application executing on the wireless communication device and/or the server may request the dedicated IP flow for the L4S protocol. The application and/or the server may request the dedicated IP flow responsive to the wireless communication device establishing the first connection with the first wireless communication node. The application and/or server may request the dedicated IP flow, to prevent network congestion during data transmission between the endpoints (e.g., UE and server).

At process 720, the wireless communication device may switch from the first connection to a second connection. The second connection may be with a second wireless communication node (e.g., a second base station 525). For example, the UE 510 may perform a mobility event from the first base station 520 to the second base station 525. A mobility event may be a change in communication between the wireless communication device and a base station. A mobility event may be triggered by the wireless communication device moving from a first service area to a second service area. The wireless communication device may switch from the first connection to the second connection responsive, to a change in the service area of the wireless communication device. For example, the UE 510 may switch from the first base station 520 to the second base station 525 when the UE 510 moves from a service area of the first base station 520 to a service area of the second base station 525. The wireless communication device may establish the second connection, to maintain a session with the endpoint (such as the server corresponding to the session supported by the first connection). For example, the wireless communication device may establish the second session with the endpoint responsive to a user of the wireless communication device accessing a resource hosted or served by the server, responsive to requesting data from the server, and so forth

At process 730, the wireless communication device may determine a support status of the L4S protocol by the second wireless communication node. For example, the UE 510 may determine if the base station 525 supports the L4S protocol. The support status of the L4S protocol may be determined according to the dedicated IP flow responsive to switching to the second connection. For example, the UE 510 may determine if the second base station 525 supports L4S, based on whether the L4S flow is maintained when a handover to the second base station 525 occurs. The wireless communication device may determine a support status of the L4S protocol after the mobility event in step 720 so that congestion marking may continue and, subsequently, network congestion does not occur. The wireless communication device may determine the support status by determining if the dedicated IP flow is accepted by the second wireless communication node. For example, the UE 510 may determine that L4S is supported by the base station 525 if the base station 525 accepts the L4S dedicated IP flow.

In some embodiments, the second wireless communication node releases the dedicated IP flow and a corresponding radio bearer, responsive to the second wireless communication node not supporting the L4S protocol. For example, the session or connection established at step 710 may include a plurality of flows between the wireless communication device and an endpoint. The second wireless communication node may release the dedicated IP flow (e.g., for the L4S protocol) and accept remaining flow(s) or other flows of the plurality of flows during to the handover. The wireless communication device may determine the support status based on the release of the dedicated IP flow. For example, the wireless communication device may determine that the second wireless communication node does not support the L4S protocol responsive to receiving an indication that a second flow of the plurality of flows was accepted during the handover, but the dedicated IP flow for L4S was rejected. If the second wireless communication node accepts the second flow but not the dedicated IP flow, it may indicate that a connection to the second communication node can be established but L4S is not supported. For example, if a base station 525 accepts a latency QoS flow, but not the L4S QoS flow, it may implicitly indicate that the L4S protocol is not supported by the base station 525.

In some embodiments, the wireless communication device may determine the support status based on a quality of service (QOS) flow identifier (5QI) value. For example, the wireless communication device may receive, from the second wireless communication node, a 5QI value. The wireless communication device may receive the 5QI value responsive to the wireless communication device requesting the IP flow for the L4S protocol for a connection with the second wireless communication node. The wireless communication device may determine the support status based on the 5QI value being a predetermined value. For example, responsive to identifying the 5QI value, the wireless communication device may compare the 5QI value to one or more known 5QI values (e.g., from a database containing information corresponding to a meaning of the 5QI value). The wireless communication device may determine the support status based on the comparison. For example, the wireless communication device may reference the 5QI value to a data structure (or the database), to determine what the particular 5QI value indicates. If the 5QI value indicates that the L4S protocol is supported, the wireless communication device may determine that the L4S protocol is supported by the second wireless communication node.

In some embodiments, the wireless communication device may determine an active status of the dedicated IP flow. The wireless communication device may determine whether the L4S protocol is supported by the second wireless communication node based on the active status of the dedicated IP flow. The wireless communication device may determine an active status of the dedicated IP flow responsive to the determining of the support status of the L4S protocol by the second wireless communication node. In some embodiments, an active status of the dedicated IP flow may indicate that the dedicated IP flow is supported by the second communication node. The active status of the dedicated IP flow may be determined by receiving an indication, from the second wireless communication node to the wireless communication device, that the dedicated IP flow is active. For example, if the UE 510 receives an indication that the dedicated IP flow is active in the base station 525, it may mean that the base station 525 supports the L4S protocol.

In some embodiments, the second wireless communication node accepts the dedicated IP flow, responsive to the second wireless communication node supporting the L4S protocol. The wireless communication device may determine the support status based on the acceptance of the dedicated IP flow. The determine the support status responsive to the acceptance of the dedicated IP flow. For example, if the base station 525 accepts the dedicated IP flow, the acceptance may be an implicit indication to the UE 510 that the base station 525 supports L4S.

In some embodiments, the wireless communication device may receive a packet on the dedicated IP flow. The packet may include an explicit congestion notification (ECN). The wireless communication device may receive a packet on the dedicated IP flow responsive to a connection being established between the wireless communication device and a wireless communication node. The ECN may be, for example, the L4S protocol or another type of ECN. The wireless communication device may receive a packet to inform the device about a possible congestion in the network and prevent the congestion from occurring.

In some embodiments, the wireless communication device may determine an inactive status of the IP flow. The wireless communication device may determine that the second wireless communication node does not support the L4S protocol based on the inactive status of the dedicated IP flow. The wireless communication device may determine an inactive status of the IP flow responsive to the wireless communication device switching from the first connection to the second connection at step 720. The status may be determined based on the rejection of the dedicated IP flow by the second wireless communication node. In some embodiments, the wireless communication device may perform congestion control using a congestion control protocol other than the L4S protocol. The wireless communication device may use a congestion control protocol other than the L4S protocol responsive to determining an inactive status of the dedicated IP flow. If a wireless communication node does not support the L4S protocol, another congestion control protocol may be used to prevent congestion during data transmission. Another congestion control protocol may be, for example, repeated halving a data bandwidth until congestion is no longer present in the network.

Referring back to FIG. 6, the process flow 600 shows an initial establishment of L4S awareness in a wireless communication system, according to an exemplary embodiment. In various embodiments, a network may explicitly communicate to a UE 510 whether the L4S protocol is supported at a base station 520, 525. For example, at an initial establishment of a data session, the network and/or the UE 510 may receive an explicit indicator that L4S is supported. The process flow 600 is shown to include various component or elements, which may be similar to or the same as the components of the system 500 described with respect to FIG. 5. The components of the process flow 600 may be in communication with each other through a variety of pathways/networking connections/interfaces.

In various embodiments, the AMF 532 may receive data from one or more of the base stations 520, 525 indicating whether or not the base station supports L4S. Process 602 may indicate a configuration data exchange between the first base station 520 and the AMF 532. For example, in various embodiments, the first base station 520 may support the L4S protocol. The configuration data exchange between the first base station 520 and the AMF 532 may contain or include data indicating that the first base station supports L4S. Similarly, process 604 may indicate a configuration data exchange between the second base station 525 and the AMF 532. For example, in various embodiments, the second base station 525 may not support L4S. The configuration data exchange between the second base station 525 and the AMF 532 may contain data indicating that the second base station does not support L4S.

In various embodiments, in addition to indicating L4S support, the base stations 520, 525 may communicate information related to L4S architecture options of the base station. In various embodiments, the base station 520, 525 may indicate L4S support and/or architecture options for various procedures. For example, the base station 520, 525 may indicate the information for a N2-interface next generation application protocol (NGAP) connection setup procedure. In various embodiments, the N2-interface GAP connection setup procedure may be a type of N2 configuration update procedure. The AMF 532 may store, maintain, or otherwise access information regarding the L4S support capabilities of the base station 520, 525. In various embodiments, at the AMF 532, L4S support may be at an AMF set level.

In various embodiments, the UE 510 may request to establish a session to connect to the server 540 (e.g., begin a data session). In various embodiments, the data session may be a Protocol Data Unit (PDU) session. For example, the UE 510 may establish a PDU session with the base station 520, as indicated by process 606. The UE 510 may also send the request to the base station 520, which may in turn forward the request to the AMF 532, as shown by process 606. The AMF 532 may facilitate establishing the connection between the UE 510 and the server 540 via the base station 520. During an initial session establishment procedure, the AMF 532 may indicate to the SMF 534 whether the network supports L4S, as shown by process 608. For example, the UE 510 may establish a PDU session with the base station 520. The base station 520 may support L4S. At process 602, the AMF 532 may receive information that the base station 520 supports L4S. The AMF 532 may communicate that support status to the SMF 534 (e.g., at process 608. In various embodiments, The AMF 532 may communicate the information to the SMF 534 through a message. The message may be, for example, a session management (SM) non-access stratum (NAS) message. Through the SM NAS message, the AMF 532 may indicate to the SMF 534 whether a serving radio access network (RAN) (e.g., base station 520) and/or the AMF connected to the base station 520 support L4S functionality. In various embodiments, L4S support at the SMF 534 may be at an SMF set level.

In various embodiments, a dynamic policy may be used by the network for establishing sessions and/or managing traffic (including a dynamic policy for support of L4S). If a dynamic policy is used, the SMF 534 may indicate support of the L4S for SM policy exchanges between the SMF 534 and a policy control function (PCF). Therefore, the SMF 534 may indicate support of L4S by the base station 520 to the PCF. In various embodiments, the PCF may support the L4S protocol. A dedicated L4S QOS flow setup may be triggered responsive to the PCF supporting the L4S protocol. The PCF may indicate the L4S QoS flow setup to the SMF 534. The indication to the SMF 534 may be used for a data network name (DNN) authorization. In various embodiments, PCF support of the L4S protocol may be at a PCF set level.

Block 610 indicates a selection of a UPF 536 by the SMF 534. In an initial establishment of L4S awareness, the SMF 534 may establish a connection between the UE 510 and a base station that supports L4S (e.g., base station 520). In various embodiments, the SMF 534 may additionally select a UPF 536 that supports L4S function. In various embodiments, the SMF 534 may have information related to whether an UPF 536 supports L4S functionality. Process 612 indicates a connection or an association between the SMF 534 and a UPF 536 that supports L4S.

In various embodiments, the SMF 534 may indicate to the UE 510 that L4S is supported by the network. Process 614 indicates a connection between the UE 510, the base station 520 that supports L4S, and the UPF 536 that supports L4S. In various embodiments, the SMF 534 may indicate to the UE 510 that L4S is supported via a PDU session accept message, indicated by process 614. The SMF 534 may generate the PDU session accept message if both the UPF 536 and the network support the L4S protocol. The PDU session accept message may serve as an indication to the UE 510 that the L4S protocol is supported by the base station 520 to which the UE 510 is connected.

In various embodiments, the SMF 534 may have information relating to support of L4S functionality. For example, the SMF 534 may have information indicating that the core network and the base station to which the UE 510 is connected support L4S functionality. The SMF 534 may indicate to the UE 510 that the network supports L4S for a PDU session. The SMF 534 may indicate to the UE 510 via, for example, a SM NAS message. In various embodiments, a bit mask may be included in the SM NAS message. The bit mask may indicate which PDU session with an active user plane connection supports L4S.

In various embodiments, the UE 510 may perform an end-to-end (E2E) L4S check using a Layer 4 procedure, shown by process 616, responsive to the establishment of the session with the server 540. A Layer 4 procedure may be, for example, the QUIC procedure. In various embodiments, one or more of the UE 510 and the server 540 may perform an L4S check or validation. The L4S validation may be performed, for example, by using an application procedure. The L4S validation may ensure that L4S is supported E2E.

In various embodiments, the base station to which the UE 510 is connected may not support L4S. The UE 510 may receive an indication that the network does not support the L4S protocol based on an indication in a SM NAS message received by the UE 510. In various embodiments, the UE 510 may switch from an L4S congestion support to another congestion support mechanism. For example, if L4S is not supported at the base station, the UE 510 may control network congestion by repeatedly halving a bandwidth of data from the PDU session. In various embodiments, the UE 510 may communicate to an application server if the UE 510 switches from the L4S protocol to another congestion support protocol.

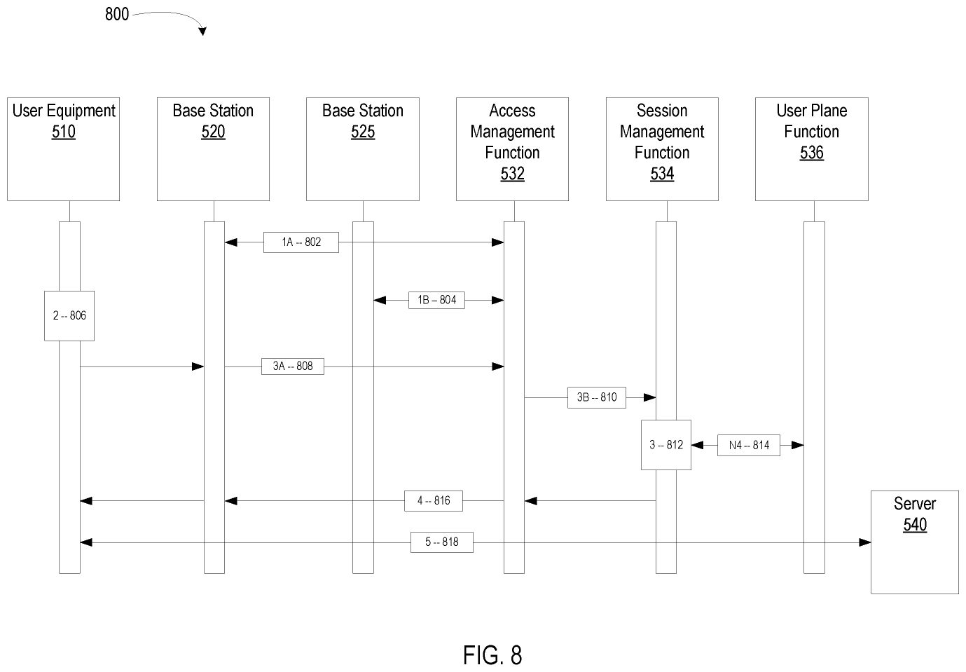

Referring now to FIG. 8, a process flow 800 illustrating a wireless communication device determining an L4S support status is shown, according to an exemplary embodiment. The process flow 800 may indicate an idle mode mobility event of a UE 510, and/or a reestablishment of a PDU session with L4S awareness. In various embodiments, an idle mobility event may be an event during which a data session between the UE 510 and the server 540 has been initiated, yet no data is being transmitted, so the UE 510 becomes idle. While the UE 510 is idle, it may also perform mobility events (e.g., move from a connection with a first base station 520 to a connection with a second base station 525). In various embodiments, the UE 510 may perform a mobility event and move from a first base station 520 that supports L4S to a second base station 525 that does not support the L4S protocol. The UE 510 may, while connected to the second base station 525, send data to the server 540. The UE 510 may need to reestablish the PDU session after an idle period, such that the UE 510 remains connected and able to transmit data. The PDU session may be reestablished between the UE 510 and the first base station 520 and/or between the UE 510 and the second base station 525.

Process 802 and process 804 may be similar to process 602 and process 604 of FIG. 6, respectively. For example, process 802 may indicate a configuration data exchange between the first base station 520 and the AMF 532. For example, in various embodiments, the first base station 520 may support L4S. The configuration data exchange between the first base station 520 and the AMF 532 may include data indicating that the first base station supports L4S. Process 804 indicates a configuration data exchange between the second base station 525 and the AMF 532. For example, in various embodiments, the second base station 525 may not support L4S. The configuration data exchange between the second base station 525 and the AMF 532 may include data indicating that the second base station does not support L4S.

Block 806 indicates an idle mode mobility. For example, the UE 510 may move from a connection with base station 520 to a connection with base station 525. In various embodiments, the UE 510 may send data to, for example, the base station 525 and/or the server 540, after being in an idle mode. A connection between the UE 510 and the UPF 536 may be reestablished in order for the UE 510 to send data (e.g., the PDU session is reestablished). As indicated at process 808, the PDU session may be reestablished between the UE 510, the base station 525, and the AMF 532. In various embodiments, the reestablishment of the PDU session may include an indication that it is an existing PDU session. During the reestablishment of the PDU session, the AMF 532 may indicate to the SMF 534 that the base station 525 does not support the L4S protocol, as shown by process 810. The SMF 534 may indicate to the UPF 536 that the base station 525 and/or the network do not support L4S, as shown by block 812 and the process 814.

In various embodiments, in the case of a mobility event (e.g., an idle mode mobility event, an active mode mobility event, etc.), the SMF 534 may subscribe to L4S capability change events from the AMF 532 (e.g., to determine or otherwise identify any events which indicate a change in L4S capability by the serving node). The SMF 534 may thus determine that L4S is not supported for a PDU session (e.g., responsive to a handover to a base station, such as base station 525, which does not support L4S). The SMF 534 may initiate the SM NAS session modification procedure responsive to determining that L4S is not supported. The SM NAS procedure may inform the UE 510 that L4S is not supported for a given PDU session with a current base station.

The SMF 534 may indicate to the UE 510 that the network and/or base station 525 does not support L4S, as shown by process 816. The indication from the SMF 534 to the UE 510 may be an explicit indication that the network does not support L4S. The UE 510 may be informed that the network does not support L4S through an absence of L4S support indication. For example, if the UE 510 does not receive an explicit notification of L4S establishment, L4S is not supported by the base station. After the user plane is reestablished, the UE 510 may perform another type of congestion control as shown by process 818. A different type of congestion control procedure may be, for example a slow start. A slow start may be a decreased initial sending rate to reduce congestion. For example, the sender may initially send data at a slow rate and gradually increase the sending rate as the network congestion improves.

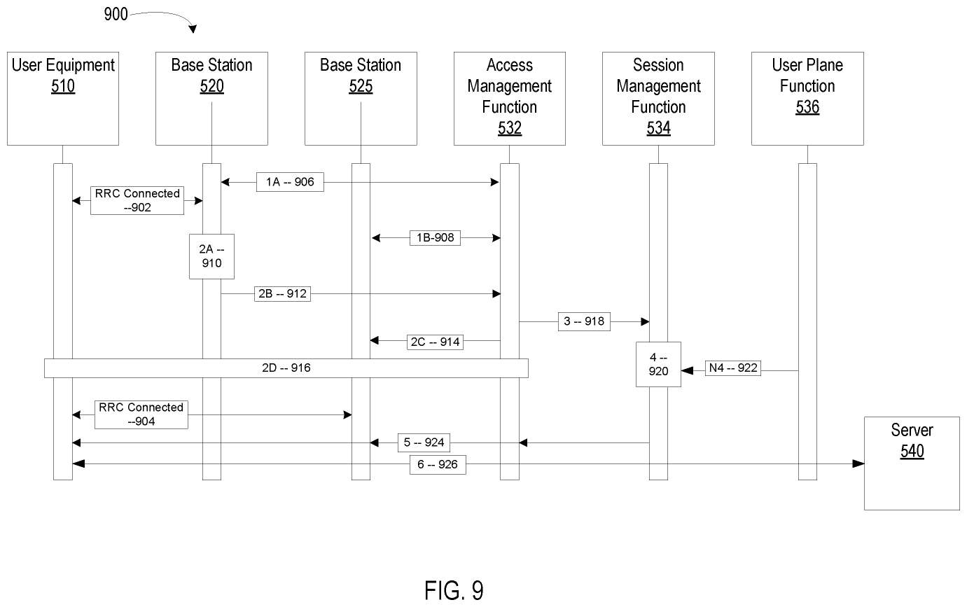

Referring now to FIG. 9, a process flow 900 illustrating a wireless communication device determining an L4S support status is shown, according to an exemplary embodiment. The process flow 900 shows a connected mode mobility with L4S awareness via an N2 interface. In various embodiments, an N2 interface may indicate that the base station 520 and the base station 525 do not communicate directly. One or more components of the core network (e.g., AMF 532) may be involved in communication between the base station 520 and the base station 525. For example, the base station 520 may only be able to communicate with the base station 525 via a core network component, such as the AMF 532. In various embodiments, a connected mode mobility event may indicate a handover of data from a first base station 520 to a second base station 525 when the UE 510 moves from the first base station 520 to the second base station 525.

In various embodiments, the UE 510 may have radio resource control (RRC) connection to the first base station 520, as shown by process 902, and a radio resource control (RRC) connection to the second base station 525, as shown by process 904. A RRC connection may establish a connection between the UE 510 and one or more of the base stations 520, 525. Processes 906 and 908 may be similar, respectively, to processes 602 and 604 of FIG. 6. For example, process 906 may indicate that there is a configuration data exchange between the base station 520 and the AMF 532. The base station 520 may support L4S. Similarly, process 908 may indicate that there is a configuration data exchange between the base station 525 and the AMF 532. The base station 525 may not support L4S. At block 910, there may be a connected mode mobility of the UE 510 from the first base station 520 to the second base station 525.

In a connected mode mobility event, the first base station 520 may initiate a handover request to the AMF 532 via an N2 interface. The first base station 520 may include an indication of a target base station with the request to the AMF. For example, the first base station 520 may initiate a handover request to the AMF 532 and indicate that the target base station is the second base station 525. The handover request is indicated by the process 912. The AMF 532 may perform a handover or handover request to the second base station 525, as shown by process 914. As shown by block 916, the handover procedures may be performed between the UE 510, the base stations 520, 525, and the AMF 532.

In various embodiments, the AMF 532 may receive an indication that the target base station (e.g., the second base station 525), does not support L4S. The AMF 532 may receive this indication via the configuration data exchange shown by process 908. The AMF 532 may communicate information regarding a support status of the base station 525 to the SMF 534, as shown by the process 918. The SMF 534 may communicate the L4S support status of the base station 525 to the UPF 536, as shown by block 920 and the process 922. As shown by process 924, the SMF 534 may indicate to the UE 510 that the base station 525 does not support L4S. The SMF 534 may indicate the support status to the UE 510 via an absence of L4S supported modification in an PDU session modification message. For example, a PDU session modification message from the SMF 534 for the UE 510 may not include explicit L4S supported modification, thus indicating that the base station 525 does not support the L4S protocol. After receiving the indication that L4S is not supported by the base station 525, the UE 510 may perform legacy congestion control with the server 540 if needed, as shown by the process 926.

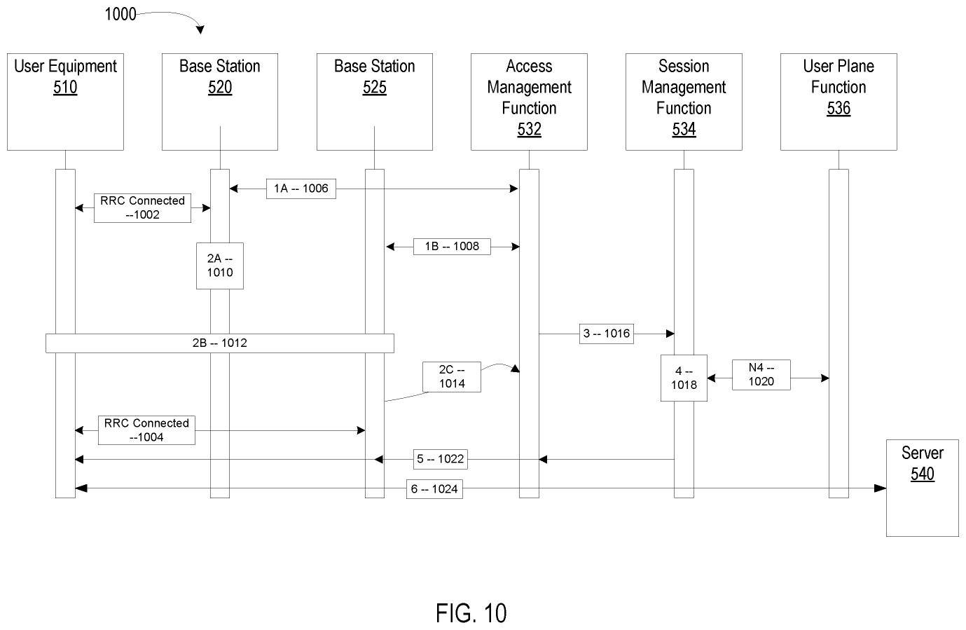

Referring now to FIG. 10, a process flow 1000 illustrating a wireless communication device determining an L4S support status is shown. The process flow 1000 shows a connected mode mobility of the UE 510 with L4S awareness. The connected mode mobility may be through an Xn interface. In various embodiments, an Xn interface may indicate that the base station 520 can communicate directly with the base station 525 without communicating with a component of the core network (e.g., AMF 532). The core network may be involved with communication only after a mobility event and/or handover has occurred between the base station 520 and the base station 525. For example, the base station 520 may communicate to the base station 525 that the UE 510 will perform a mobility event from the base station 520 to the base station 525. After the mobility event has occurred, the SMF 534 may indicate an L4S support status of the base station 525 to the UE 510 via the AMF 532.

In various embodiments, the UE 510 may perform a connected mode mobility event. For example, the UE 510 may switch from a connection with the first base station 520 to a connection with the second base station 525. In various embodiments, the UE 510 may have a radio resource control (RRC) connection to the first base station 520, as shown by process 1002, and a radio resource control (RRC) connection to the second base station 525, as shown by process 1004. A RRC connection may establish a connection between the UE 510 and the base stations 520, 525. Processes 1006 and 1008 may be similar, respectively, to processes 602 and 604 of FIG. 6. For example, process 1006 may indicate that there is a configuration data exchange between the base station 520 and the AMF 532. The base station 520 may support L4S. Similarly, process 1008 may indicate that there is a configuration data exchange between the base station 525 and the AMF 532. The base station 525 may not support L4S.

During an Xn based handover, the UE 510 may perform a mobility event and move from the source first base station 520 to the target second base station 525. Block 1010 indicates a connected mode mobility from the first base station 520 to the second base station 525. Block 1012 indicates an Xn based handover procedure between the source base station 520 and the target base station 525. After the handover occurs, the target base station 525 may communicate to the AMF 532 to request that a batch switch be performed, as indicated by the process 1014.

In various embodiments, connected mode mobility via an Xn interface may follow a handover procedure similar to the N2 handover described with respect to FIG. 9 (with the exception of different communication supported between base stations 520, 525 as is the case between Xn and N2 interface-based communication). For example, in various embodiments, the AMF 532 may receive an indication that the second base station 525 does not support L4S. The AMF 532 may receive this indication via the configuration data exchange shown by process 1008. The AMF 532 may communicate information regarding the support status of the base station 525 to the SMF 534, as shown by the process 1016. The SMF 534 may communicate the L4S support status of the base station 525 to the UPF 536, as shown by block 1018 and the process 1020. As shown by process 1022, the SMF 534 may indicate to the UE 510 that the base station 525 does not support L4S. The SMF 534 may indicate this to the UE 510 via an absence of L4S supported modification in an PDU session modification message. For example, a PDU session modification message from the SMF 534 for the UE 510 may not include explicit L4S supported modification, thus indicating that the base station 525 does not support the L4S protocol. After receiving the indication that L4S is not supported by the base station 525, the UE 510 may perform an alternate method of congestion control with the server 540 if needed, as shown by the process 1024.

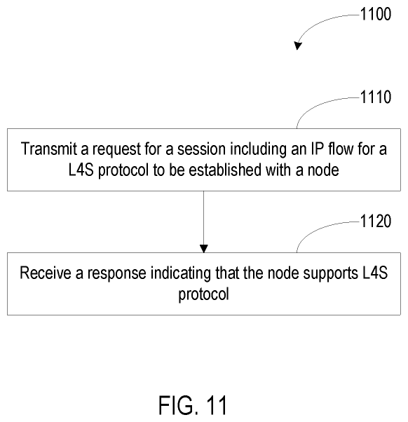

Referring now to FIG. 11, a flowchart of a method 1100 is shown for determining UE awareness for L4S in cellular networks using a per-node level capability exchange, according to an example embodiment of the present disclosure. The method 1100 may be performed, executed by, or otherwise implemented by the devices, components, elements, or hardware described above with reference to FIG. 1-FIG. 10. As a brief overview, at step 1110, a wireless communication device may transmit a request for a session, including an IP flow for an L4S protocol, to be established with a wireless communication node. At step 1120, the wireless communication device may receive a response to the request indicating that the wireless communication node supports the L4S protocol.

At process 1110, a wireless communication device may transmit a request for a session to be established with a wireless communication node. For example, a wireless communication device, such as the UE 510, may transmit a request for a first connection to be established with a wireless communication node, such as the base station 520. In various embodiments, the wireless communication device may transmit the request to an access management function of a core network. For example, the wireless communication device may transmit the request to the AMF 532. The connection may be or include a data session, such as a PDU session. The wireless communication device may request that the session includes a dedicated IP flow for the L4S protocol. The wireless communication device may request to establish the session with an endpoint (such as a server). For example, the wireless communication device may request to establish the session with the endpoint responsive to a user of the wireless communication device accessing a resource hosted or served by the server, responsive to requesting data from the server, and so forth.

In some embodiments, the request sent at step 1110 may be sent at a first time instance. In some embodiments, the wireless communication node is a first wireless communication node. Step 1110 may further include initiating a handover from the first wireless communication node to a second wireless communication node. For example, a handover may include a switch from a connection between the first wireless communication device (e.g., UE 510) and the first wireless communication node (e.g., base station 520) to a connection between the first wireless communication device and the second wireless communication node (e.g., base station 525). The first wireless communication device may initiate the handover responsive to a mobility event at a second time instance. The mobility event may include the first wireless communication device moving from a service area of the first wireless communication node to a service area of the second wireless communication node.

In some embodiments, the mobility event may be or include an idle mode mobility event. During an idle mobility event, the wireless communication device may switch from a connection with the first wireless communication node to a connection with the second wireless communication node. However, no data may be transmitted between the wireless communication device and the wireless communication node to which the device is connected. Prior to and/or during an idle mobility event, the session may preexist with the first wireless communication node. For example, at step 1110, the session requested by the wireless communication device (e.g., UE 510) may be a preexisting session with the first wireless communication node (e.g., base station 520). For example, a session may be reestablished after a lack of data transmission has indicated an idle mode. After the idle mode mobility event (e.g., switching wireless communication node connections while no data is transmitted), the second wireless communication node may reestablish the session with the wireless communication device.

In some embodiments, the mobility event may be or include a connected mode mobility event. In a connected mode mobility event, the wireless communication device may transmit data to the wireless communication node to which it is connected. For example, the wireless communication device may transmit data to the first wireless communication node and may transmit data to the second wireless communication node after the mobility event and handover from the first wireless communication node to the second wireless communication node.

In some embodiments, the handover may be performed via at least one of an N2 interface or Xn interface. An N2 interface may include communication between the first wireless communication node and the access management function. The communication may indicate that a target for the handover is the second wireless communication node. For example, the first wireless communication node (e.g., base station 520) may indicate to the access management function (e.g., AMF 532) that the handover may occur from the first wireless communication node to the second wireless communication node (e.g., base station 525). An Xn interface may include direct communication between the first wireless communication node and the second wireless communication node. Subsequently, the second wireless communication node may indicate the handover event to the access management function. For example, a handover may occur between the first wireless communication node (e.g., base station 520), and the second wireless communication node (e.g., base station 525). The second wireless communication node may inform the AMF 532 to perform a path switch responsive to the handover occurring.

At process 1120, the wireless communication device may receive a response to the request. The wireless communication device may receive the request via the AMF from a session management function (e.g., SMF 534) of the core network. For example, the SMF may generate a response to the request. The SMF may communicate the response to the AMF, and the AMF may deliver the response to the wireless communication device. The response may indicate that the L4S protocol is supported by the wireless communication node.

In some embodiments, the response to the request may include a session management (SM) non-access stratum (NAS) message. For example, the SMF may generate the response as a SM NAS message. In some embodiments, the SM NAS message may include a bit mask indicating that the session has an active user plane connection that supports L4S. For example, the wireless communication device may be connected to the wireless communication node. The connection may be or include an active user plane connection, which the SM NAS message may include.

In some embodiments, the wireless communication device may receive an indication indicating the L4S protocol is not supported by the second wireless communication node. The indication may be received by the wireless communication device via the AMF from the SMF For example, the SMF may generate a message or indication that the L4S protocol is not supported by the second wireless communication node. The SMF may communicate the message to the AMF. The AMF may deliver the message to the wireless communication device.

In some embodiments, the handover may include a modification to the session between the first wireless communication node and the second wireless communication node. The modification may correspond to the second wireless communication node not supporting the L4S protocol. In some embodiments, the modification may be or include a session management (SM) non-access stratum (NAS) modification. The SM NAS modification may be initiated by the SMF. The SM NAS medication may indicate to the wireless communication device that the L4S protocol is not supported under the second wireless communication node.

In some embodiments, the SMF may determine a support status of the L4S protocol for the wireless communication node based on configuration information received via the AMF from the wireless communication node. For example, the wireless communication node may communicate configuration information regarding a support status of the L4S protocol to the AMF (e.g., whether or not the wireless communication node is configured to support the L4S protocol). The AMF may deliver the information to the SMF. The SMF may determine the support status of L4S based on an indication from the configuration information.

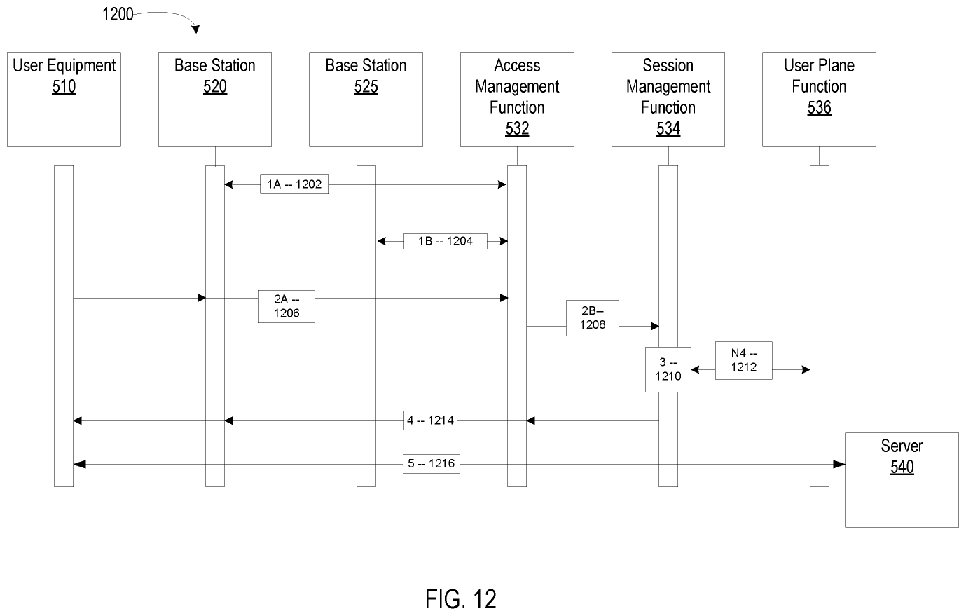

Referring now to FIG. 12, a process flow 1200 illustrating a wireless communication device determining an L4S support status is shown. The process flow 1200 may be similar to the process flow 600 of FIG. 6.

In various embodiments, the UE 510 may request to establish a session to connect to the server 540 (e.g., begin a data session)(e.g., at process 1206, the UE 510 sends the request to the base station 520 and the AMF 532 to establish the connection between the UE 510 and the server 540 shown at process 1216). For example, the UE 510 may request to establish a session to connect with the server 540, responsive to accessing a resource or application hosted by the server, responsive to a user accessing a local instance of the resource (e.g., on the UE 510), responsive to requesting data to be retrieved from the server 540, and so forth. The UE 510 may send the request to the AMF 532, as shown by process 1206. The AMF 532 may facilitate establishing the connection between the UE 510 and the server 540. In various embodiments, the data session may be a Protocol Data Unit (PDU) session.

In various embodiments, when the UE 510 initiates a PDU session, the UE 510 may indicate whether the L4S is desired for the PDU session if the registration area supports L4S. The serving SMF 534, based on the UE 510 indication and either a local policy or the dynamical policy from the serving PCF, may authorize the L4S on a per PDU session basis. In various embodiments, the procedure may be similar to an “always-on” PDU session authorization procedure. If the L4S is facilitated for the requested PDU session, the SMF 534 may indicate to the UE 510 that the L4S protocol supported. The SMF 534 may indicate the L4S support status to the UE 510 via a PDU session accept message.

In various embodiments, an indication of L4S support may be determined at a registration area level. In various embodiments, one or more of the base stations 520, 525 may be located in a registration area. In the first registration area, all base stations in the registration area may support L4S. For example, base station 520 may support the L4S protocol and may be located in a first registration area. In the second registration area, all base stations in the registration area may not support L4S. For example, base station 525 may not support L4S and may be located in a second registration area. Base station support of the L4S protocol may be at the registration area level. In various embodiments, support of the L4S protocol at the AMF 532 may be at an AMF set level. In various embodiments, support of the L4S protocol at the SMF 534 may be at an SMF set level. In various embodiments, support of the L4S protocol at the UPF 536 may be at a UPF level. In various embodiments, the process flow 1200 may include policy control function (PCF) support of the L4S protocol. In various embodiments, support of the L4S protocol at the PCF may be at the PCF set level.

In various embodiments, the UE 510 may perform a mobility event and switch from a connection with the first base station 520 in a first registration area to a connection with the second base station 525 in a second registration area. When the UE 510 switches from the first registration area to the second registration area, the UE 510 may receive an indication from the network regarding whether the second registration area supports the L4S protocol. In various embodiments, if the UE 510 switches from a first base station within a first registration area to a second base station also within the first registration area, the UE 510 may already know whether L4S is supported. During a mobility registration procedure and a periodic registration procedure, the AMF 532 may indicate to the UE 510 whether the L4S is possible and/or available in the registration area. In various embodiments, a mobility registration procedure may include determining a registration area and a support status of the registration area after a mobility event has occurred. In various embodiments, a periodic registration procedure may include determining a registration area and a support status of the registration area after a predefined period of time that the UE 510 has been connected to a base station in the registration area. A periodic registration procedure may occur if a mobility event has not occurred and/or if the UE 510 performs an idle mobility event. A registration accept notification or message may be delivered to the UE 510. The registration accept notification may include various fields, such as (but not limited to): Registration Area, [Mobility restrictions], [PDU Session status], [Periodic Registration Update timer], and/or [L4S supported indication].

If, during a mobility event, the UE 510 moves from a first registration area to a second registration area, the mobility registration update procedure may be executed. The AMF 532 may indicate that L4S is not supported in a registration accept message for the second registration area. In response, the UE may fallback a congestion control from L4S to another congestion protocol. The UE 510 may communicate to an application server on such a fallback event. In various embodiments, if the second registration area does not support L4S, the serving AMF 532 may notify the serving SMF 532. The SMF 532 may be expected to and/or may modify PDU sessions which have L4S authorized to indicate to the UE 510 that the L4S protocol is not authorized or supported. The SMF 532 may deactivate the L4S specific QoS flows in those PDU sessions where L4S is not supported.

In various embodiments, the AMF 532 may be responsible for determining L4S support of a base station and communicating the support status to the UE 510. For example, the AMF 532 may have information related to the locations of one or more registration areas. The AMF 532 may also have information related to a support status for each registration area. In various embodiments, the UE 510 may request a data or PDU session with a base station 520, as indicated by the process 1206. The request may be forwarded to the AMF 532, as shown by the process 1204. The AMF 532 may provide a registration area-level indication of L4S support to the UE 510.

The AMF 532 may have information that network supports L4S capability in the current registration area. The AMF 532 may receive the information, for example, by operation configuration. The AMF 532 may alternatively or additionally receive the information through querying a network repository function (NRF). All the base stations in the current registration area may support L4S. All tracking areas (TAs) in the current registration area may also support L4S. The AMF set, the SMF set, the PCF sets and/or the UPF(s) that serve the current registration area (e.g., the first registration area) may support L4S. The UE 510 and/or the server 540 may perform L4S validation by using an application procedure to ensure L4S is end-2-end supported.

In various embodiments, a registration area may identify the base stations within the registration area via a range of identifiers. Each base station may have a unique identifier. The identifier may be, for example, a unique string of characters. Each base station may broadcast the unique identifier. When the UE 510 performs a mobility event and is served by a particular base station, the UE 510 has information related to the location of the base station (e.g., what registration area the base station is part of). For example, the UE 510 may be in a first registration area. The first registration area may support L4S. The UE 510 may perform a mobility event and move to a second registration area that does not support L4S. The UE 510 may send a request to the AMF 532 to receive an updated L4S support status of the registration area. The AMF 532 may communicate an indication of the L4S support status to the UE 510.

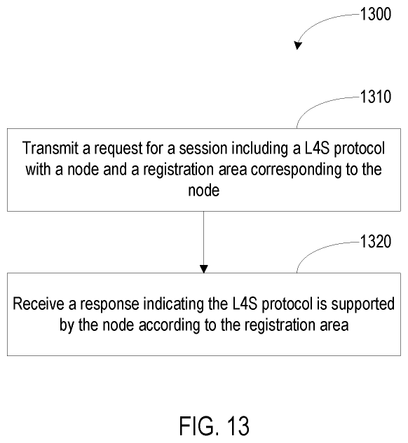

Referring now to FIG. 13, a method 1300 is shown for determining L4S awareness in a cellular network via an indication per a registration area level, according to an example embodiment of the present disclosure. The method 1300 may be performed, executed by, or otherwise implemented by the devices, components, elements, or hardware described above with reference to FIG. 1-FIG. 12. As a brief overview, at step 1310, a wireless communication device may transmit a request to establish a session with a wireless communication node. The request may indicate that an L4S protocol is to be used for the session, and a registration area corresponding to the wireless communication node. At step 1320, the wireless communication device may receive a response to the request indicating that the L4S protocol is supported by the wireless communication node according to the registration area.

At process 1310, a wireless communication device may transmit a request for an establishment of a data session with a wireless communication node. For example, a wireless communication device, such as the UE 510, may transmit a request for a first connection to be established with a wireless communication node, such as the base station 520. In various embodiments, the wireless communication device may transmit the request to an access management function of a core network. For example, the wireless communication device may transmit the request to the AMF 532. The connection may be or include a data session, such as a PDU session. The wireless communication device may request that the session includes a dedicated IP flow for the L4S protocol and a registration area corresponding to the wireless communication node. The wireless communication device may request to establish the session with an endpoint (such as a server). For example, the wireless communication device may request to establish the session with the endpoint responsive to a user of the wireless communication device accessing a resource hosted or served by the server, responsive to requesting data from the server, and so forth.

In some embodiments, the request may be sent at a first time instance. In some embodiments, the wireless communication node may be a first wireless communication node. Step 1310 may further include initiating a mobility registration update procedure with the AMF. The wireless communication device may initiate the mobility registration update procedure responsive to a mobility event at a second time instance to a second registration area. A mobility registration update procedure may include switching from a connection to a first wireless communication node in a first registration area to a connection to a second wireless communication node in a second registration area.

At process 1320, the wireless communication device may receive a response to the request. In various embodiments, the wireless communication device may receive the response via the AMF from a session management function (SMF) of the core network (e.g., SMF 534). For example, the SMF may generate a response to the request. The SMF may communicate the response to the AMF, and the AMF may deliver the response to the wireless communication device. The response may indicate that the L4S protocol is supported by the wireless communication node. The indication of L4S protocol support may be according to the registration area. For example, in a registration area, all of the wireless communication nodes within a first registration area may support the L4S protocol. Likewise, all of the wireless communication nodes within a second registration area may not support the L4S protocol. The indication that the wireless communication node supports the L4S protocol may be generated responsive to determining that a registration area of the wireless communication node supports the L4S protocol.

In some embodiments, the response to the request may be received by the wireless communication device in a session accept message from the SMF. For example, the SMF may deliver a session accept message to the wireless communication device responsive to a determination that the registration area supports the L4S protocol.

In some embodiments, the SMF may determine that the L4S protocol is supported by the wireless communication node. The determination that the L4S protocol is supported may be responsive to or based on determining that each wireless communication node in the registration area support the L4S protocol. For example, if it is determined that a registration area supports the L4S protocol, it can further be determined that a wireless communication node within the registration area supports the L4S protocol. In some embodiments, the SMF determines that each wireless communication node in the registration area support the L4S protocol by querying a network repository function (NRF) of the core network. The NRF may transmit data to the SMF, responsive to the query, that indicates a support status of the wireless communication nodes in the registration area.

In some embodiments, the wireless communication device may transmit a message to confirm that the L4S protocol is to be maintained for the session. The message may be transmitted to the AMF. For example, the wireless communication device (e.g., UE 510) may transmit the message to the AMF 532. The message may be transmitted during a periodic registration procedure. A periodic registration procedure may be performed by the wireless communication device responsive to an idle period of the wireless communication device. The periodic registration procedure may indicate to the wireless communication node and/or the server that the wireless communication device remains connected to the wireless communication node. In some embodiments, the wireless communication device may receive a second response to the message. The second response may indicate that the L4S protocol is supported by the wireless communication node based on the registration area.

In some embodiments, the wireless communication device may receive, via the AMF from the SMF, an indication indicating the L4S protocol is not supported in the second registration area. For example, after a mobility registration update procedure, the wireless communication device may switch from communication with a first wireless communication node (e.g. base station 520) in a first registration area that does support the L4S protocol to a second wireless communication node (e.g., base station 525) in a second registration area that does not support the L4S protocol.

In some embodiments, the wireless communication device may perform congestion control using a congestion control protocol other than the L4S protocol. The wireless communication device may perform congestion control responsive to receiving the indication that the L4S protocol is not supported in the second registration area. For example, if the wireless communication device is connected to a wireless communication node that does not support the L4S protocol, the wireless communication device may still determine if there is congestion in the network. For example, the wireless communication device may use a congestion control protocol that halves the bandwidth of a data flow for the session.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B”’ can include only ‘A,’ only ‘B,’ as well as both ‘A’ and ‘B.’ Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method comprising:
transmitting, by a wireless communication device, to an access management function (AMF) of a core network, a request for a session to be established with a wireless communication node, the request indicating a low queuing latency, low loss, and scalable throughput (L4S) protocol is to be used for the session, and a registration area corresponding to the wireless communication node; and
receiving, by the wireless communication device, via the AMF from a session management function (SMF) of the core network, a response to the request, the response indicating that the L4S protocol is supported by the wireless communication node according to the registration area.

2. The method of claim 1, wherein the SMF determines that the L4S protocol is supported by the wireless communication node, based on determining that each wireless communication node in the registration area support the L4S protocol.

3. The method of claim 2, wherein the SMF determines that each wireless communication node in the registration area support the L4S protocol by querying a network repository function (NPF) of the core network.

4. The method of claim 1, wherein the request is sent at a first time instance and the wireless communication node is a first wireless communication node, the method further comprising:
initiating, by the wireless communication device responsive to a mobility event at a second time instance to a second registration area, a mobility registration update procedure with the AMF; and
receiving, by the wireless communication device, via the AMF from the SMF, an indication indicating the L4S protocol is not supported in the second registration area.

5. The method of claim 4, further comprising performing congestion control using a congestion control protocol other than the L4S protocol.

6. The method of claim 1, further comprising performing, by the wireless communication device, with a server, an L4S validation using an application procedure, to determine whether the L4S protocol is supported along an end-to-end network path between the wireless communication device and the server.

7. The method of claim 1, further comprising:
transmitting, by the wireless communication device, to the AMF, during a periodic registration procedure, a message to confirm that the L4S protocol is to be maintained for the session; and
receiving, by the wireless communication device, a second response to the message, the second response indicating that the L4S protocol is supported by the wireless communication node based on the registration area.

8. The method of claim 1, wherein the response is received in a session accept message from the SMF.

9. A wireless communication device, comprising:
a transceiver; and
one or more processors configured to:
transmit, by a wireless communication device, to an access management function (AMF) of a core network, a request for a session to be established with a wireless communication node, the request indicating a low queuing latency, low loss, and scalable throughput (L4S) protocol is to be used for the session, and a registration area corresponding to the wireless communication node;
receive, by the wireless communication device, via the AMF from a session management function (SMF) of the core network, a response to the request, the response indicating that the L4S protocol is supported by the wireless communication node based on the registration area.

10. The device of claim 9, wherein the SMF determines that the L4S protocol is supported by the wireless communication node, based on determining that each wireless communication node in the registration area support the L4S protocol.

11. The device of claim 10, wherein the SMF determines that each wireless communication node in the registration area support the L4S protocol by querying a network repository function (NPF) of the core network.

12. The device of claim 9, wherein the request is sent at a first time instance and the wireless communication node is a first wireless communication node, the one or more processors further configured to:
initiating, by the wireless communication device responsive to a mobility event at a second time instance to a second registration area, a mobility registration update procedure with the AMF; and
receiving, by the wireless communication device, via the AMF from the SMF, an indication indicating the L4S protocol is not supported in the second registration area.

13. The device of claim 12, the one or more processors further configured to perform congestion control using a congestion control protocol other than the L4S protocol.

14. The device of claim 9, the one or more processors further configured to perform, by the wireless communication device, with a server, an L4S validation using an application procedure, to determine whether the L4S protocol is supported along an end-to-end network path between the wireless communication device and the server.

15. The device of claim 9, the one or more processors further configured to:
transmit, by the wireless communication device, to the AMF, during a periodic registration procedure, a message to confirm that the L4S protocol is to be maintained for the session; and
receive, by the wireless communication device, a second response to the message, the second response indicating that the L4S protocol is supported by the wireless communication node based on the registration area.

16. The device of claim 9, wherein the response is received in a session accept message from the SMF.

17. A non-transitory computer readable medium storing instructions that, when executed by one or more processors, cause the one or more processors to:
transmit, by a wireless communication device, to an access management function (AMF) of a core network, a request for a session to be established with a wireless communication node, the request indicating a low queuing latency, low loss, and scalable throughput (L4S) protocol is to be used for the session, and a registration area corresponding to the wireless communication node; and
receive, by the wireless communication device, via the AMF from a session management function (SMF) of the core network, a response to the request, the response indicating that the L4S protocol is supported by the wireless communication node based on the registration area.

18. The non-transitory computer readable medium of claim 17, wherein the SMF determines that the L4S protocol is supported by the wireless communication node, based on determining that each wireless communication node in the registration area support the L4S protocol.

19. The non-transitory computer readable medium of claim 18, wherein the SMF determines that each wireless communication node in the registration area support the L4S protocol by querying a network repository function (NPF) of the core network.

20. The non-transitory computer readable medium of claim 17, wherein the request is sent at a first time instance and the wireless communication node is a first wireless communication node, the method further comprising:
initiating, by the wireless communication device responsive to a mobility event at a second time instance to a second registration area, a mobility registration update procedure with the AMF; and
receiving, by the wireless communication device, via the AMF from the SMF, an indication indicating the L4S protocol is not supported in the second registration area.
